(19) United States
(12) Patent Application Publication
(10) Pub. No.: US 2014/0052569 A1
(43) Pub. Date: Feb. 20, 2014

(54) Methods and Systems for Matching a Professional with a Referral Opportunity

(71) Applicant: Kyruus, Inc., Boston, MA (US)

(72) Inventors: Julie Keunhee Yoo, Boston, MA (US); Graham Gardner, Sudbury, MA (US); Vinay Seth Mohta, Newton, MA (US); Puneet Batra, Cambridge, MA (US)

(73) Assignee: Kyruus, Inc., Boston, MA (US)

(21) Appl. No.: 14/059,499

(22) Filed: Oct. 22, 2013

Related U.S. Application Data
(63) Continuation of application No. 13/653,675, filed on Oct. 17, 2012.
(60) Provisional application No. 61/548,370, filed on Oct. 18, 2011.

(51) Int. Cl. G06Q 30/06

(52) U.S. Cl. CPC G06Q 30/0623
USPC 705/26.7

(57) ABSTRACT

A method for matching a professional with a referral opportunity includes automatically generating, by a profile generator executing on a first computing device, a profile of a professional. The method includes receiving, by an analysis engine executing on the first computing device, from a second computing device, an identification of a referral opportunity having at least one requirement. The method includes determining, by the analysis engine, that the generated profile satisfies the at least one requirement. The method includes transmitting, by the analysis engine, to the second computing device, the identification of the professional.

### CROSS-REFERENCE TO RELATED APPLICATIONS

This application claims priority from U.S. patent application Ser. No. 13/653,675, filed on Oct. 17, 2012, entitled “Methods and Systems for Profiling Professionals,” which claims priority from U.S. Provisional Patent Application Ser. No. 61/548,370, filed on Oct. 18, 2011, entitled “Methods and Systems for Profiling Professionals,” each of which is hereby incorporated by reference.

### BACKGROUND

The disclosure relates to referral management. More particularly, the methods and systems described herein relate to matching a professional with a referral opportunity.

Conventional professional referrals are highly dependent on a personal network of the referring professional. A primary care physician, for example, may know a handful of specialists for treating some diagnoses, and none at all for other diagnoses. When a patient complains to the physician of joint pain, for instance, the physician may refer the patient to the only orthopedist with whom the physician has had previous dealings, whether or not that orthopedist is suitable or available for that patient. If the physician does not know personally of a specialist, the physician can typically do little more than the patient herself could by consulting lists of doctors and choosing one by guesswork. Compounding this issue is the conventional lack of access, for professionals and clients alike, to information concerning the relative merits of different professionals to whom a client could be referred.

### BRIEF SUMMARY

In one aspect, a method includes automatically generating, by a profile generator executing on a first computing device, a profile of a professional. The method includes receiving, by an analysis engine executing on the first computing device, from a second computing device, an identification of a referral opportunity having at least one requirement. The method includes determining, by the analysis engine, that the generated profile satisfies the at least one requirement. The method includes transmitting, by the analysis engine, to the second computing device, the identification of the professional.

In another aspect, a system includes a profile generator executing on a first computing device and generating a profile of a professional. The system includes an analysis engine (i) executing on the first computing device, (ii) receiving from a second computing device, an identification of a referral opportunity having at least one requirement, (iii) determining that the generated profile satisfies the at least one requirement, and (iv) transmitting, to the second computing device, the identification of the professional.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2 is a block diagram depicting one embodiment of a system for profiling a professional;

FIG. 3A is a flow diagram depicting an embodiment of a method for profiling a professional;

FIG. 3B is a screen shot depicting one embodiment of profiles generated by a profile generator;

FIG. 3C is a screen shot depicting one embodiment of a description of a level of expertise for each of a plurality of profiled professionals;

FIG. 3D is a screen shot depicting an embodiment of a description of a level of expertise for each of a plurality of profiled professionals;

FIG. 4A is a flow diagram depicting one embodiment of a method for verifying a level of compliance of professional profile data;

FIG. 4B is a screen shot depicting one embodiment of a user interface displaying a profile of an institution;

FIG. 5A is a flow diagram depicting one embodiment of a method for generating and transmitting customized disclosure reports for professionals;

FIG. 5B is a block diagram depicting one embodiment of a system for generating and transmitting customized disclosure reports for professionals;

FIG. 6A is a flow diagram depicting one embodiment of a method for identifying a future match between a professional and an industry opportunity;

FIG. 6B is a flow diagram depicting one embodiment of a method for identifying a future match between a professional and an industry opportunity;

FIG. 6C is a flow diagram depicting one embodiment of a method for identifying a future match between a professional and an industry opportunity;

FIG. 6D is a flow diagram depicting one embodiment of a method for matching a professional with an industry opportunity;

FIG. 6E is a flow diagram depicting one embodiment of a system for matching a professional with a referral opportunity;

FIG. 6F is a flow diagram depicting one embodiment of a method for matching a professional with a referral opportunity;

FIG. 6G is a flow diagram depicting an embodiment of a method for matching a professional with a referral opportunity;

FIG. 7 is a flow diagram depicting one embodiment of a method for identifying a fair market value for compensating a professional;

FIG. 8 is a flow diagram depicting one embodiment of a method for identifying an incentive provided by an industry opportunity for a professional;

FIG. 9 is a flow diagram depicting one embodiment of a method for identifying at least one of a level of expertise and a level of influence of a professional on an industry professional;

FIG. 10 is a flow diagram depicting one embodiment of a method for analyzing at least one of a level of expertise and a level of influence of an industry professional on a professional; and

FIG. 11 is a flow diagram depicting one embodiment of a method for analyzing an influence on a behavior of a professional.

### DETAILED DESCRIPTION

In some embodiments, the methods and systems described herein profile professionals and entities. Before describing methods and systems for generating and using such profiles in detail, however, a description is provided of a network in which such methods and systems may be implemented.

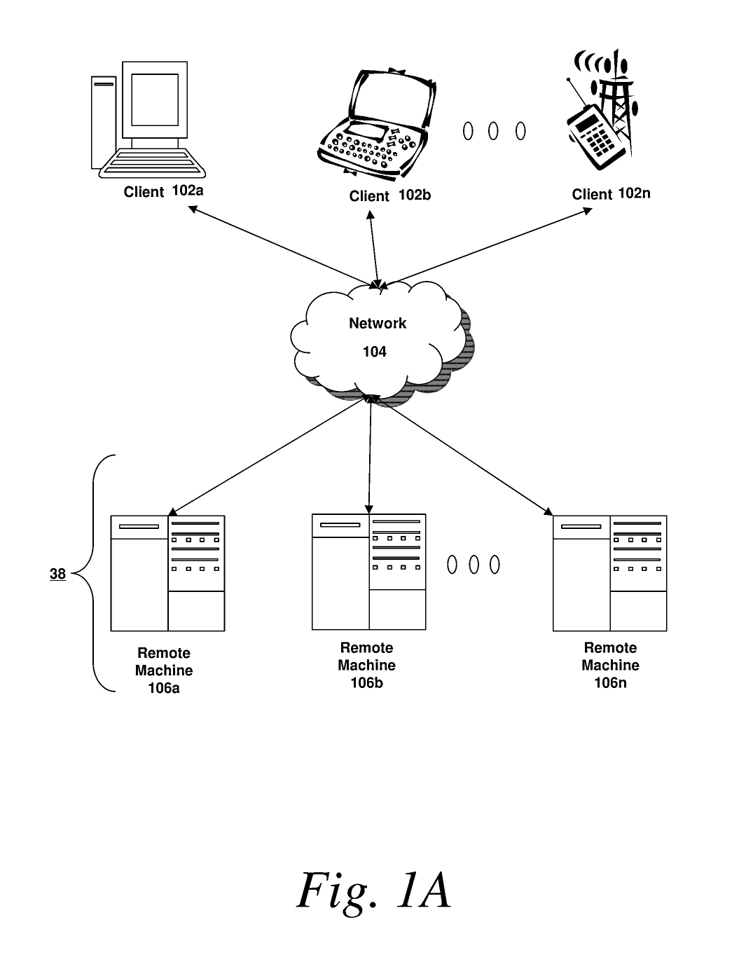

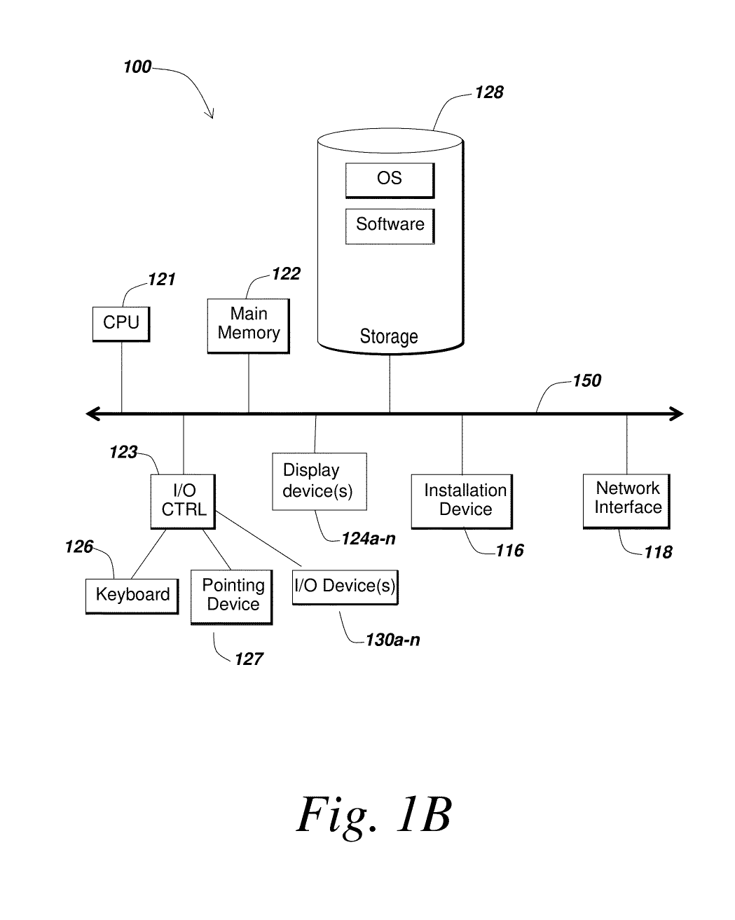

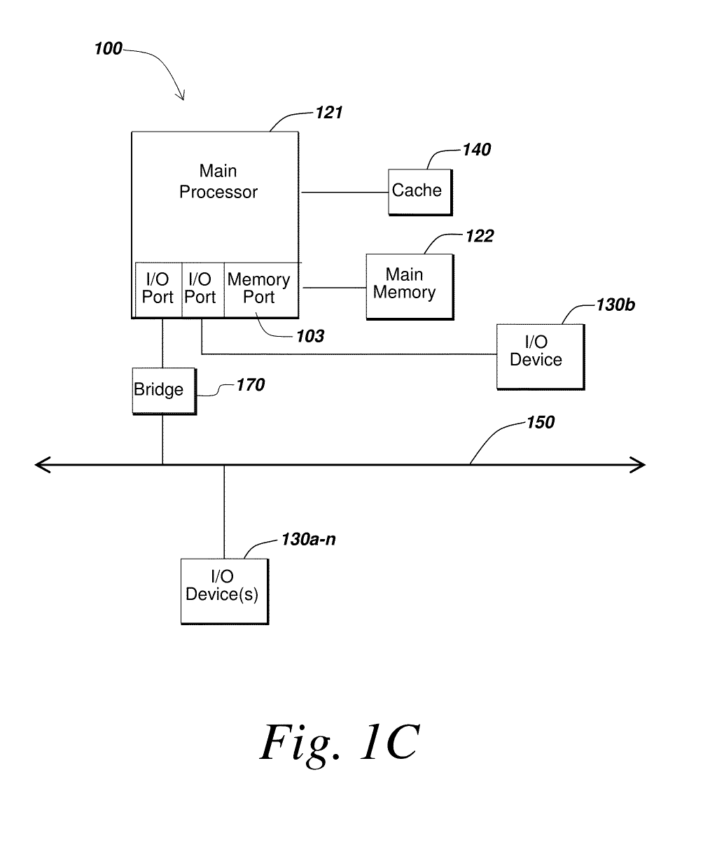

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash.; the Oracle iPlanet web server products provided by Oracle Corporation of Redwood Shores, Calif.; or the BEA WEBLOGIC products provided by BEA Systems, of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. The I/O devices may be controlled by an I/O controller 123 as shown in FIG. 1B. Furthermore, an I/O device may also provide storage and/or an installation medium 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch disks, 5.25-inch disks or ZIP disks, a CD-ROM drive, a CD-R/RW drive, a DVD-ROM drive, tape drives of various formats, USB device, hard-drive or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, of which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7 and WINDOWS VISTA, all of which are manufactured by Microsoft Corporation of Redmond, Wash.; MAC OS manufactured by Apple Inc. of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill., USA; Kyocera of Kyoto, Japan; Samsung Electronics Co., Ltd., of Seoul, Korea; Nokia of Finland; Hewlett-Packard Development Company, L.P. and/or Palm, Inc., of Sunnyvale, Calif., USA; Sony Ericsson Mobile Communications AB of Lund, Sweden; or Research In Motion Limited, of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices, manufactured by Apple Inc., of Cupertino, Calif. In another of these embodiments, the digital audio player may function as both a portable media player and as a mass storage device. In other embodiments, the computing device 100 is a digital audio player such as those manufactured by, for example, and without limitation, Samsung Electronics America, of Ridgefield Park, N.J.; Motorola Inc. of Schaumburg, Ill.; or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices, manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the iPad line of devices, manufactured by Apple Inc.; the PlayBook, manufactured by Research in Motion; the Cruz line of devices, manufactured by Velocity Micro, Inc. of Richmond, Va.; the Folio and Thrive line of devices, manufactured by Toshiba America Information Systems, Inc. of Irvine, Calif.: the Galaxy line of devices, manufactured by Samsung; the HP Slate line of devices, manufactured by Hewlett-Packard; and the Streak line of devices, manufactured by Dell, Inc. of Round Rock, Tex.

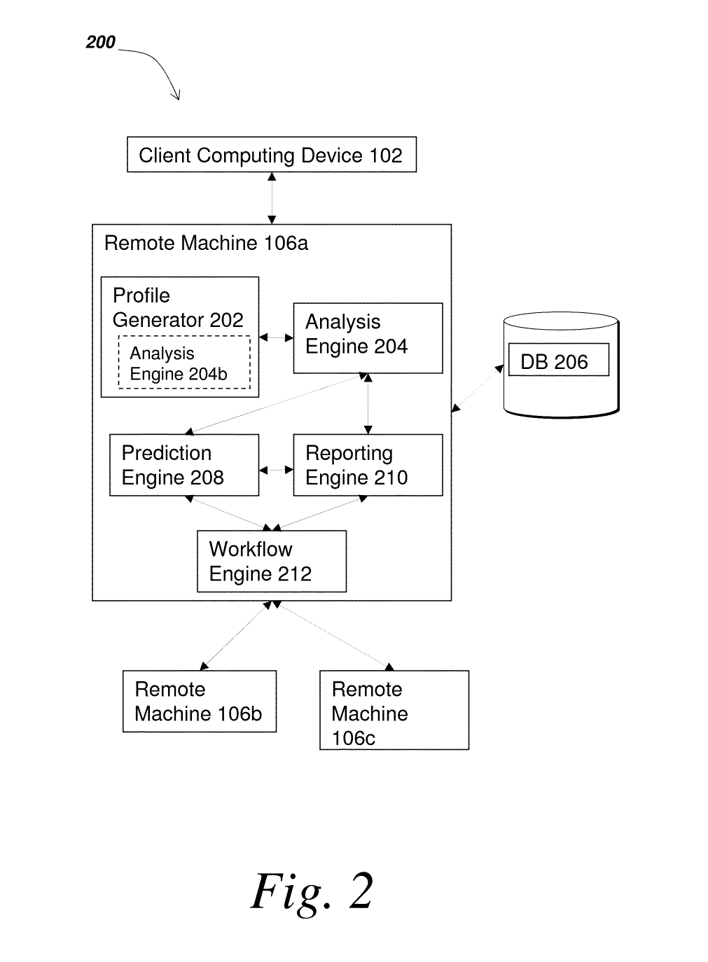

Referring now to FIG. 2, a block diagram depicts one embodiment of a system for profiling at least one of a professional and an entity. In brief overview, the system includes a client device 102, remote machines 106a-c, a profile generator 202, an analysis engine 204, a prediction engine 208, a reporting engine 210, and a workflow engine 212. In some embodiments, the profile generator includes a second analysis engine 204b.

The profile generator 202 automatically generates a profile of at least one of a professional and an entity. In some embodiments, the profile includes at least one identification of a professional connection of the at least one of the professional and the entity. In other embodiments, the profile includes at least one lifestyle characteristic of a professional.

The analysis engine 204 analyzes the generated profile. The analysis engine 204 determines, responsive to the analysis, a level of expertise of a professional in an industry. In some embodiments, a profiled individual or entity has a level of domain expertise. In some embodiments, a level of expertise refers to a level of familiarity with a particular subject. In other embodiments, the analysis engine 204 determines a level of influence. For example, the analysis engine 204 may determine that a profiled individual or entity has a level of influence over one or more other individuals or entities based, at least in part, on the level of expertise the profiled individual or entity has in a particular industry or domain. In one embodiment, a level of expertise refers to one or more internal factors—factors specific to, or internal to, a profiled professional—while a level of influence refers to one or more external factors—factors independent of the professional and relating to the professional's interactions with others. Examples of factors considered in establishing levels of expertise include numbers of articles, numbers of grants, levels of involvement in particular organizations and a number of organizations with which the individual interacts (e.g., a number of interactions an academic has with a professional in industry or vice versa). Examples of factors considered in establishing levels of influence include external factors associated with a profiled professional, such as a reporting structure relative to another professional or a professional connection such as a mentoring, training or other connection between the profiled professional and a second professional. In other embodiments, a level of influence refers to a degree of reach of a professional or for how long the professional influences others' behaviors. In further embodiments, the analysis engine 204 determines both a level of expertise and a level of influence. The analysis engine 204 transmits, to a second computing device, an identification of the determined level of expertise.

In one embodiment, the professional is a medical professional. For example, the professional may be any kind of doctor, a medical student, a nurse, a pharmacist, or a healthcare professional. In another embodiment, the professional is an individual working in a professional services environment such as, without limitations, a lawyer, a consultant, real estate professional, or financial services professional (e.g., accountants and bankers). In some embodiments, a professional provides support services to other professionals in an industry. For example, an industry professional may be a sales person selling pharmaceutical products to doctors or a jury consultant assisting litigators with jury selection. In other embodiments, professionals include students (of any discipline), education professionals (teachers, school administrators, etc.), athletes, and politicians.

Referring now to FIG. 2, and in greater detail, the profile generator 202 generates a profile of a professional or an entity. In one embodiment, the profile generator 202 accesses a database 206 to retrieve data associated with the professional or entity. In another embodiment, the profile generator 202 accesses a second computing device 106 to retrieve data associated with the professional or entity; for example, the profile generator 202 may query a remotely located database or computer. In still another embodiment, the profile generator 202 accesses a second computing device 106 to identify a professional or entity for whom to generate a profile.

In some embodiments, the profile generator 202 includes a second analysis engine 204b (depicted in shadow in FIG. 2). In one of these embodiments, the second analysis engine 204b analyzes data retrieved by the profile generator 202. In another of these embodiments, the second analysis engine 204 determines whether to include the analyzed data in the generated profile. In one example, the second analysis engine 204b may include the functionality of the analysis engine 204. In another example, the second analysis engine 204b is a version of the analysis engine 204 that has been customized to include functionality for determining whether to include data in a generated profile. In other embodiments, the profile generator 202 is in communication with a second analysis engine 204b. In further embodiments, the profile generator 202 accesses the analysis engine 204, which makes a determination as to whether to include data in a generated profile.

In some embodiments, the profile generator 202 stores a generated profile in a database 206. In some embodiments, the database 206 is an ODBC-compliant database. For example, the database 206 may be provided as an ORACLE database, manufactured by Oracle Corporation of Redwood Shores, Calif. In other embodiments, the database 206 can be a Microsoft ACCESS database or a Microsoft SQL server database, manufactured by Microsoft Corporation of Redmond, Wash. In still other embodiments, the database may be a custom-designed database based on an open source database, such as the MYSQL family of freely available database products distributed by MySQL AB Corporation of Uppsala, Sweden. In some embodiments, the database 206 is maintained by, or associated with, a third party.

The analysis engine 204 analyzes a generated profile, and determines, responsive to the analysis, a level of expertise of the professional in an industry. In one embodiment, the analysis engine 204 includes functionality for retrieving stored profiles from a database 206. In another embodiment, the analysis engine 204 includes functionality for requesting profiles and receiving profiles from the profile generator 202. In still another embodiment, the analysis engine 204 includes functionality for accessing previously analyzed profiles for comparison with a generated profile.

Referring still to FIG. 2, the system includes a prediction engine 208. In one embodiment, the prediction engine 208 receives data from the analysis engine 204. In another embodiment, the prediction engine 208 receives data from the profile generator 202. In still another embodiment, the prediction engine 208 retrieves information from a database 206. In yet another embodiment, the prediction engine 208 predicts future modifications to a professional's profile or level of expertise.

In one embodiment, the prediction engine 208 accesses data ontologies (including, in some instances, different ontologies for different verticals), algorithms and processes that organize, collect and disambiguate industry transaction payments from data sources (e.g., ‘Doctor X was paid $50 for food services’ vs. ‘Pfizer reimbursed Doctor Y $200 as part of a speaking engagement’). In another embodiment, the prediction engine 208 accesses frameworks that compare data sets against other available data sets (e.g., hospital web sites, state board information, publication history, etc.) to help fill in gaps when information is only partially available. In still another embodiment, the prediction engine 208 executes algorithms that, because of the size of the data set, allow the use of one piece of data to assess the importance of another piece of data.

In some embodiments, the prediction engine 208 uses a normalized, cleaned data set to drive a predictive model of interactions. In one embodiment, the prediction engine 208 analyzes a data set to identify types of engagements valuable to a professional; for example, by a frequency comparison to a set of industry transactions that have occurred. In another embodiment, the prediction engine 208 identifies the patterns that typically lead up to such engagements in advance of such engagement actually occurring. In yet another embodiment, secondary variables and external data sets (e.g., macroeconomic conditions) are used to further improve accuracy and create finer and finer categories that describe professionals' behaviors. In some embodiments, the system includes an architecture in which components periodically monitor a plurality of data sources and analyze periodically updated data models that combine and merge secondary data with more direct data.

In one embodiment, the system includes a presentation layer that provides user-facing context to the analytics. In another embodiment, the presentation layer provides user-generated data back to the profile generator 202, creating an interactive feedback loop of user-generated data. In still another embodiment, information is exposed to the end user (e.g., any type of professional) who may, for example, annotate predictions for correctness, thus generating a new data stream that the prediction engine 208 uses to refine future predictions and/or that the profile generator 202 uses to refine future profile generation. In a further embodiment, the end user may access the presentation layer in order to generate queries; for example, the end user may make requests for identifications of professional profiles or requests for identifications of individuals who satisfy requirements for industry opportunities, via the presentation layer, which may be provided as a web site including at least one user interface with which the end user may submit queries.

The system 200 may include a workflow engine 212. In one embodiment, the workflow engine 212 maintains a state for one or more processes managed by the remote machine 106a. For example, the workflow engine 212 may record a status of a profile being analyzed by the analysis engine 204. In another example, the workflow engine 212 may record a status indicating that the prediction engine 208 has generated a prediction of a modification to a professional profile but that the profile generator 202 has not yet updated the professional profile to make note of the prediction. As another example, the workflow engine 212 may record a status indicating that the analysis engine 204 has generated a recommendation of a professional profile to transmit to a first professional in connection with an industry opportunity managed by a second professional but note that the second professional has not yet contacted the first professional. In embodiments in which the remote machine 106a provides scheduling resources facilitating a connection between, for example, a plurality of professionals, the workflow engine 212 may record a status of the scheduling process. In embodiments in which the remote machine 106a provides functionality facilitating an authorization of a connection between a professional and a client (e.g., by confirming that an insurance company authorizes an appointment between a physician and a patient), the workflow engine 212 may record a status of the authorization process. In embodiments in which the remote machine 106a provides functionality facilitating generation and transmission of customized disclosure reports on behalf of a professional, the workflow engine 212 may record a status of a customized disclosure report as the customized disclosure report is, for example, generated, approved for transmission, and filed with the appropriate entity. In some embodiments, the workflow engine 212 provides status reports to other components executing on, or in communication with, the remote machine 106a. In other embodiments, the workflow engine 212 provides status reports to other computing devices, such as, for example, the client computing device 102 and the remote machine 106b.

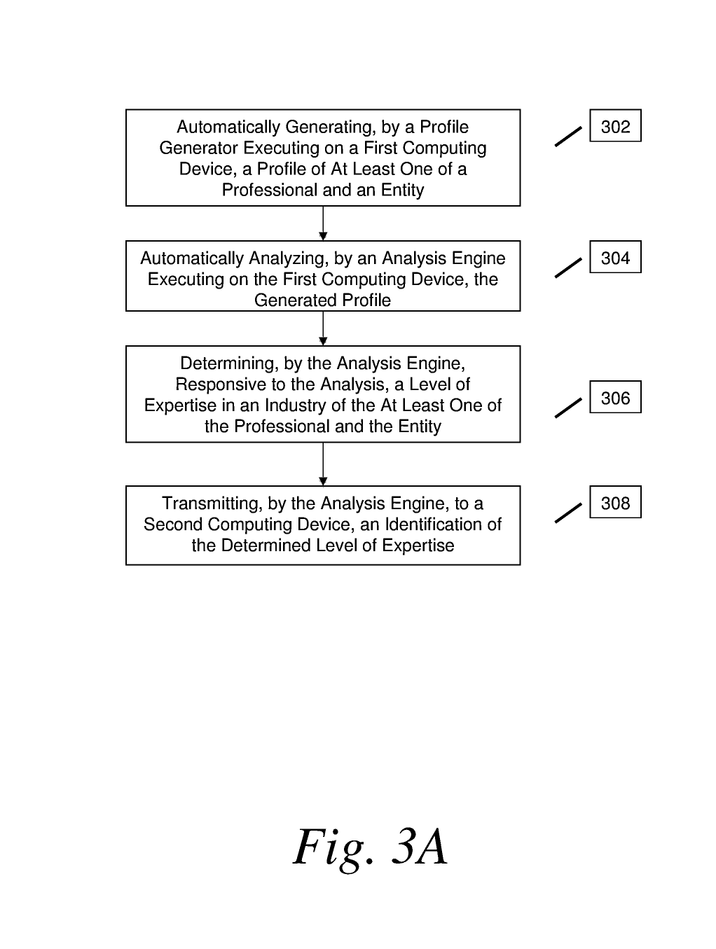

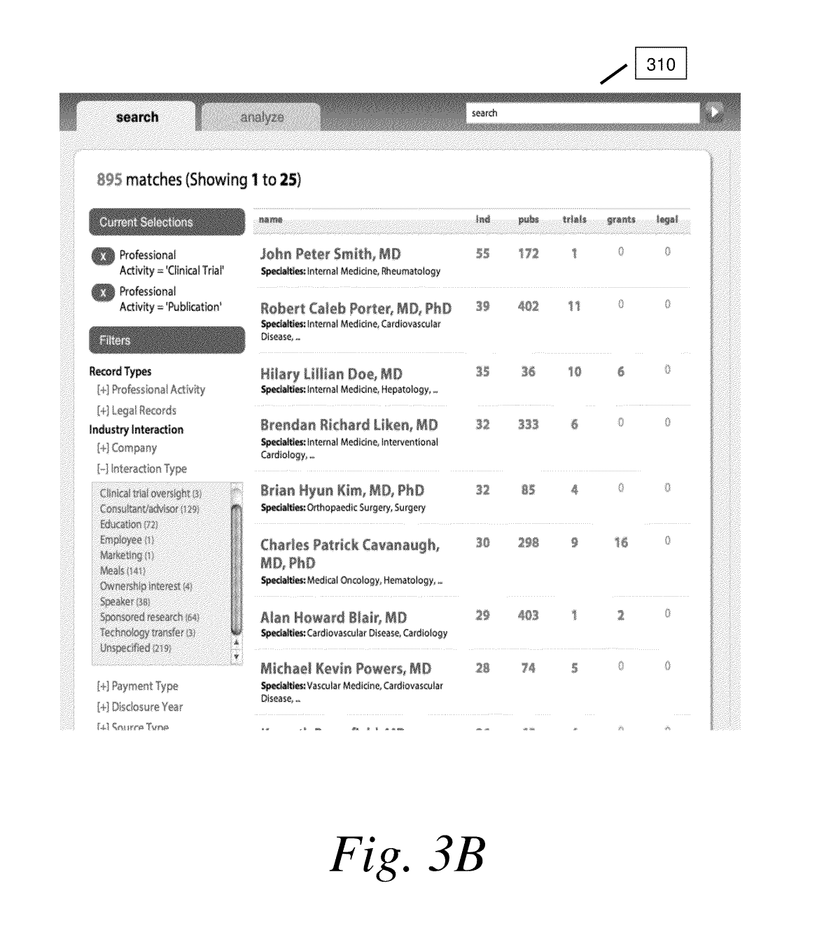

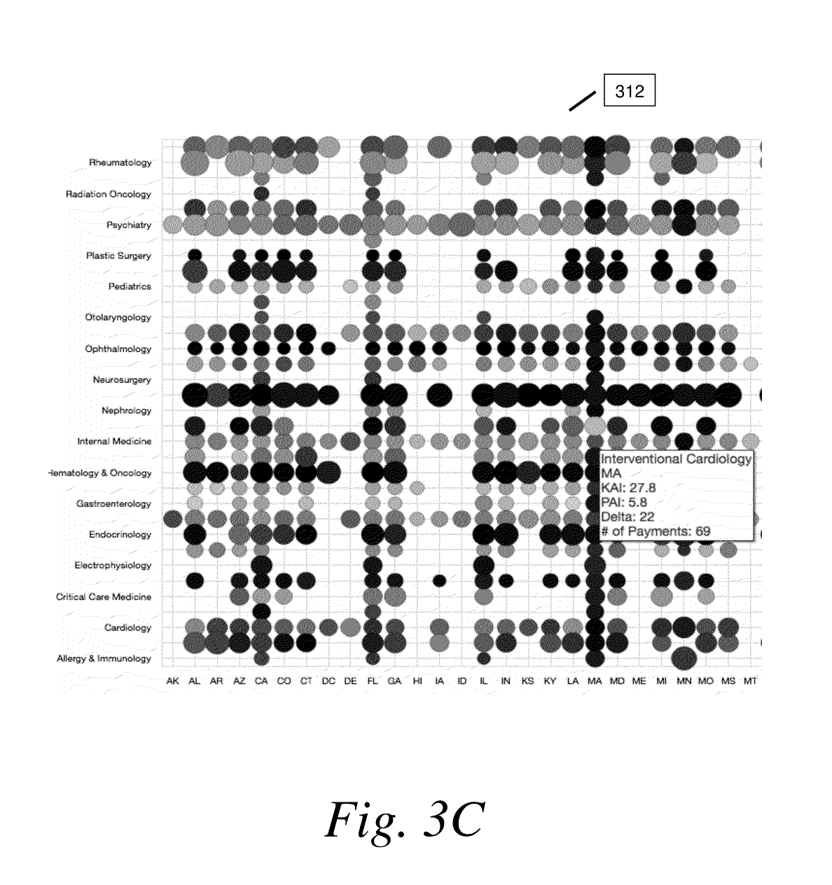

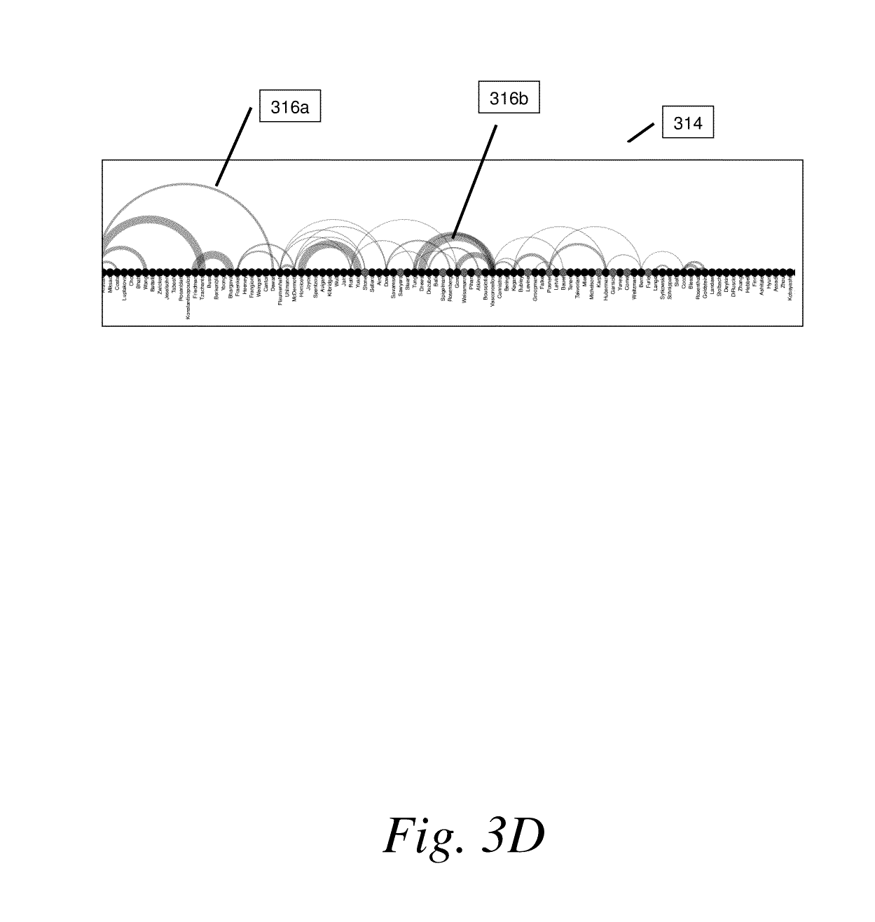

Referring now to FIG. 3A, a flow diagram depicts one embodiment of a method for profiling at least one of a professional and an entity. In brief overview, the method includes automatically generating, by a profile generator executing on a first computing device, a profile of at least one of a professional and an entity (302). The method includes analyzing, by an analysis engine executing on the first computing device, the generated profile (304). The method includes determining, by the analysis engine, responsive to the analysis, a level of expertise in an industry of the at least one of the professional and the entity (306). The method includes transmitting, by the analysis engine, to a second computing device, an identification of the determined level of expertise (308).

Referring now to FIG. 3A, and in greater detail, the profile generator 202 generates a profile of at least one of a professional and an entity (302). In one embodiment, the profile generator 202 generates an initial profile of either the professional or the entity automatically and without any input from the professional. In such an embodiment, the profile generator 202 generates the profile without the professional requesting the generation of the profile and without the professional or the entity providing any information to the system. In another embodiment, the profile generator 202 may receive input from the professional or the entity modifying the automatically generated profile; for example, the remote machine 106 may execute a web server displaying a web page from which the professional or an individual associated with the entity can make modifications to the profile after the profile generator 202 generates the profile.

Referring to FIG. 3B, a screen shot depicts one embodiment of profiles generated by the profile generator 202. In one embodiment, a user interface 310 displays a listing of profiled professionals. As shown in FIG. 3B, by way of example, a listing of a profiled professional may include a summary of the professional's specialties, a number of publications by the professional, a number of grants, and a number of trials participated in. As shown in FIG. 3B, the user interface 310 may provide functionality allowing users to search for profiled professionals.

Referring back to FIG. 3A, and in one embodiment, the profile generator 202 accesses local and remote databases to automatically generate the profile. In another embodiment, the profile generator 202 identifies connections the professional or entity has to other professionals or entities—including, for example, co-workers, employers, employees, mentors, mentees, colleagues, co-authors, co-presenters, and vendors. For example, the profile generator 202 may search, without limitation, databases of publications (e.g., journal databases), hospital databases (e.g., to find out where a doctor works), databases of current and former academic faculty (e.g., to find out where someone taught or teaches, or which professors a professional studied under), social media databases, databases of sports club or gym memberships, and databases of alumni (e.g., to determine where the professional went to school). In still another embodiment, the profile generator 202 may search databases including, without limitation, databases storing information relating to demographics, professional writing (publications, etc.), disciplinary, legal, medical, economic, and credentialing information. In some embodiments, the profile generator 202 accesses primary data. In other embodiments, the profile generator 202 accesses secondary data. In still other embodiments, the profile generator 202 accesses some data directly and some data indirectly, for example, by inferring information or relationships from other data (i.e., inferring the existence of mentoring relationships). In further embodiments, the profile generator 202 accesses user-generated data. In some embodiments, the profile generator 202 accesses publicly available information. In other embodiments, the profile generator 202 accesses proprietary databases.

In some embodiments, the profile generator 202 accesses data including, without limitation, a level of education, an affiliation with an educational institution, a type of profession, an area of specialization within a profession, an identification of a professor, an identification of a mentor, an identification of an employer, publications, presentations, professional affiliations, memberships, types of clients, office buildings, an identification of a colleague, an identification of a geographical area within which the professional works or lives, biographical information, and areas of expertise; data not explicitly associated with a professional attribute of the professional may be referred to as a lifestyle characteristic. In some embodiments, the profile generator 202 accesses user-generated data. In other embodiments, the profile generator 202 accesses interaction data such as what drugs physicians prescribed, what procedures they followed, to whom they refer patients or colleagues, preferences as to brand, and lifecycle data.

In some embodiments, the profile generator 202 analyzes accessed data to determine whether to include the accessed data in a profile. In other embodiments, the profile generator 202 determines whether accessed data is duplicative of data already in the profile. For example, the profile generator 202 may perform entity resolution (e.g., determining that “Doctor J. Reynolds” is the same individual as “Jonathan Reynolds, MD”). In one of these embodiments, the profile generator 202 determines whether accessed data indicates that data already in the profile is no longer current or has been modified over time. In further embodiments, the profile generator 202 may identify data to include in a profile using a chain of inference. For example, analyzing a professional's name associated with a publication in a well-regarded journal may allow the profile generator 202 to determine that the professional has a particular area of domain expertise; the area of domain expertise and the professional's name may allow the profile generator 202 to perform a search of a database providing additional data relating to the professional (e.g., a license number, membership, employer, or other data).

In some embodiments, the profile generator 202 is not dependent upon self-entry of data. In other embodiments, the profile generator 202 accesses passively collected data to generate a profile. In one of these embodiments, the profiled individual or entity is not aware of the data collection process. In another of these embodiments, the profile generator 202 accesses administrative or clinical systems to generate a profile. By way of example, and without limitation, administrative systems may include billing, operational, or human resources systems. As another example, and without limitation, clinical systems may include electronic medical record systems or case registries.

In one embodiment, the profile generator 202 generates a profile for a professional; for example, and without limitation, the profile generator 202 may generate a profile of a physician. In another embodiment, the profile generator 202 generates a profile for a provider of a good or service; the profile generator 202 may generate a profile for a diverse set of providers including, by way of example and without limitation, a provider such as a medical device company, a pharmaceutical company, a professional services company, or individuals employed by such companies. In still another embodiment, the profile generator 202 generates an institutional profile. For example, as indicated above, the profile generator 202 may generate a profile for a company, which may include entities of varied corporate structures (for-profit, not-for-profit, non-profit, and charitable organizations generally). In yet another embodiment, the profile generator 202 generates a profile of an opportunity. For example, the profile generator 202 may generate a profile for an opportunity such as a job opportunity (e.g., a potential client looking to hire a professional, an opportunity in a particular industry such as a consulting or speaking opportunity, or an opportunity with an entity seeking to hire a professional on a contract-, full-, or part-time basis).

In one embodiment, the profile generator 202 uses the generated profile to generate a second profile. For example, in generating an entity's profile, the profile generator 202 may incorporate data from profiles associated with employees of the entity. As another example, in generating an individual's profile, the profile generator 202 may incorporate data from profiles associated with direct reports, mentees, mentors, or other profiled individuals. In some embodiments, therefore, the profile includes at least one identification of a professional connection of the profiled entity or individual. In other embodiments, the profile includes at least one identification of a lifestyle characteristic of a profiled individual (e.g., of memberships, hobbies, activities, travel preferences, or other characteristics that may not be related to the individual's profession).

The analysis engine automatically analyzes the generated profile (304). In one embodiment, the analysis engine 204 analyzes the generated profile to identify characteristics indicative of a level of expertise.

In some embodiments, the analysis engine 204 analyzes the generated profile to identify characteristics indicative of a level of influence, which, in one of these embodiments, includes a degree of reach of a physician or for how many others the physician has a level of influence or for how long the physician influences others' behaviors. In some embodiments, drivers of influence include publications, grants, patents, referral volume, number of years of experience, degrees of risk, degrees of compliance, and tenure at particular hospitals. In other embodiments, levels of expertise are factors internal to the profiled professional, such as, without limitation, publications, grants, and experience; levels of influence may be factors external to the profiled professional, such as reporting structure or training structure.

In one embodiment, the analysis engine 204 analyzes a network of professionals to which the profiled professional belongs. The analysis engine 204 may identify ways in which the profiled professional stands out from peers in the network of professionals. The analysis engine 204 may identify characteristics that the profiled professional has in common with peers in the network of professionals. The analysis engine 204 may identify professionals in the network who are farther along in their careers than the profiled professional and compare and contrast the two. In some embodiments, the analysis engine 204 may analyze any or all of the data accessed by the profile generator 202 including, but not limited to, information listed above in connection with FIG. 2.

The analysis engine determines, responsive to the analysis, a level of expertise in an industry of the at least one of the professional and the entity (306). The analysis engine 204 may, for example, determine that a publication generated by the profiled professional is accessed by a majority of the members of his or her professional network or by influential members of the industry. In some embodiments, the level is provided as a descriptive term or phrase. In other embodiments, the level is provided as a binary value (e.g., “expert” or “not an expert”). In further embodiments, however, the level is not provided as a binary value but as a range based upon—and varying based upon—one or more weights. For example, the analysis engine 204 may be configured to weight certain types of profile data more or less heavily than others and to combine the various weights of various profile data to generate a level of expertise; in generating a profile of a researcher, for example and without limitation, the analysis engine 204 may count a recent publication in a prestigious journal as worth 0.7 points, while only weighing employment with a second tier institution as 0.2 and then combine the two to generate an overall level of expertise as 0.9 (e.g., out of 1.0).

The analysis engine transmits to a second computing device, an identification of the determined level of expertise (308). In one embodiment, the analysis engine 204 transmits the identification of the determined level of expertise to the professional. In another embodiment, the analysis engine 204 transmits the identification of the determined level of expertise to an employer of the professional. In still another embodiment, the analysis engine 204 transmits the identification of the determined level of expertise to a second professional; for example, the second professional may be a student seeking a mentor, a vendor seeking to sell a product in the industry and looking for an influential advocate within the industry, a job hunter seeking employment with an influential member of the industry, or other professional. In embodiments in which the analysis engine 204 determines a level of influence of the profiled professional, the analysis engine 204 may transmit the determined level of influence to the second computing device in addition to, or instead of, the level of expertise.

In some embodiments, the analysis engine 204 may make an identification of a profiled individual or entity available to another individual or entity. For example, the analysis engine 204 may make an identification of a profiled institution available to a professional who would benefit from an opportunity with the profiled institution (e.g., by sending a professional an identification of an industry opportunity to an academic or individual outside the industry with a profile of the entity offering the industry opportunity and an identification of a level of influence or expertise of the entity).

Referring now to FIG. 3C, a screen shot depicts one embodiment of a description of a level of expertise for each of a plurality of profiled professionals. As shown in FIG. 3C, the analysis engine 204 may generate an index 312 of levels of expertise for each of a plurality of professionals; the index may be referred to as an affinity index. The index 312, by way of example, may include listings of specialties or types of professionals and regions in which the professionals work and include an interface with which users may compare levels of expertise of various professionals.

Referring now to FIG. 3D, a screen shot depicts one embodiment of a description of a level of expertise for each of a plurality of profiled professionals. As shown in FIG. 3D, the analysis engine 204 may generate a graphical depiction 314 of the varying levels of expertise of a number of profiled professionals. As an example, the graphical depiction 314 may include a line 316 connecting two professionals to indicate a connection and may use a characteristic of the line 316, such as a width of the line 316, to indicate a level of expertise the professionals have on each other. By way of example, line 316a is a much thinner line than line 316b and, in one embodiment, this may indicate that the professionals connected by line 316a are not as influential on one another as the professionals connected by line 316b.

In some embodiments, the analysis engine 204 receives a profile of a second professional and compares the generated profile with the profile of the second professional. Referring again to FIG. 3A, and in connection with FIG. 2, in one embodiment, the prediction engine 208 executing on the first computing device generates a prediction of a future modification to the generated profile, responsive to the comparison. In another of these embodiments, the prediction engine 208 predicts a future level of expertise of the at least one of professional and the entity. For example, the analysis engine 204 may receive a profile of a mentor to a profiled professional and compare the mentor's profile with the generated profile. Based on the comparison, the prediction engine 208 may generate a prediction of a modification to the generated profile—for example, the analysis may indicate that every one of the mentor's previous mentees who attained a certain level of education went on to obtain jobs at a prestigious institution, as well as indicate that the profiled professional attained that level of education; the prediction engine 208 may evaluate the analysis and determine that the generated profile may eventually be modified to reflect employment at the prestigious institution. The prediction engine 208 may also generate a prediction of a future level of expertise by the profiled professional—for example, to reflect an increased level of expertise given the likelihood of attaining employment at the prestigious institution.

In some embodiments, the prediction engine 208 accesses a neural network to generate the prediction. In other embodiments, the prediction engine 208 accesses one or more actuarial tables to generate the prediction. In further embodiments, systems and methods executing the prediction engine 208 provide access to a more efficient, superior quality prediction of expertise than a system based on manual entry of data or based on self-reported data due to the choice of data inputs used in creating a predictive model, a blend of algorithms used in creating the predictive model, and use of a feedback loop and/or machine learning to improve the quality of the predictive model.

In some embodiments, the profile generator 202 generates a profile for an entire organization; for example, in addition to profiling a professional, the system may generate profiles for companies, academic institutions, professional associations, or other entities. In one of these embodiments, the analysis engine 204 analyzes profiles for individuals within the organization to develop a profile for the organization as a whole. In another of these embodiments, the analysis engine 204 analyzes the organizational profile to generate a level of expertise of the organization. By way of example, a teaching hospital hiring highly qualified doctors and renowned for its work in a particular medical specialty may have a high level of expertise in that industry; such a level of expertise would be relevant to, for example, a medical student seeking to work in the medical specialty, a medical device company seeking to receive the perspective of reputable doctors on a new device, or a patient seeking a certain level of expertise from his or her doctor. In other embodiments, the profile generates a profile for an organization independent of generating a profile for any individual professional affiliated with the organization (e.g., by generating a profile for a hospital without generating profiles for individual employees of the hospital).

Referring again to FIG. 2, the system includes a reporting engine 210. In one embodiment, the reporting engine 210 receives data from the analysis engine 204. In another embodiment, the reporting engine 210 receives data from the prediction engine 208. In still another embodiment, the reporting engine 210 retrieves information from a database 206. In yet another embodiment, the reporting engine 210 generates reports and transmits them to remote machines 106b and 106c. For example, the reporting engine 210 may transmit profiles to industry professionals seeking to contact influential professionals. In another example, the reporting engine 210 may generate and distribute disclosure reports on behalf of a profiled professional to a third party, such as the professional's employer, affiliates, or other third party.

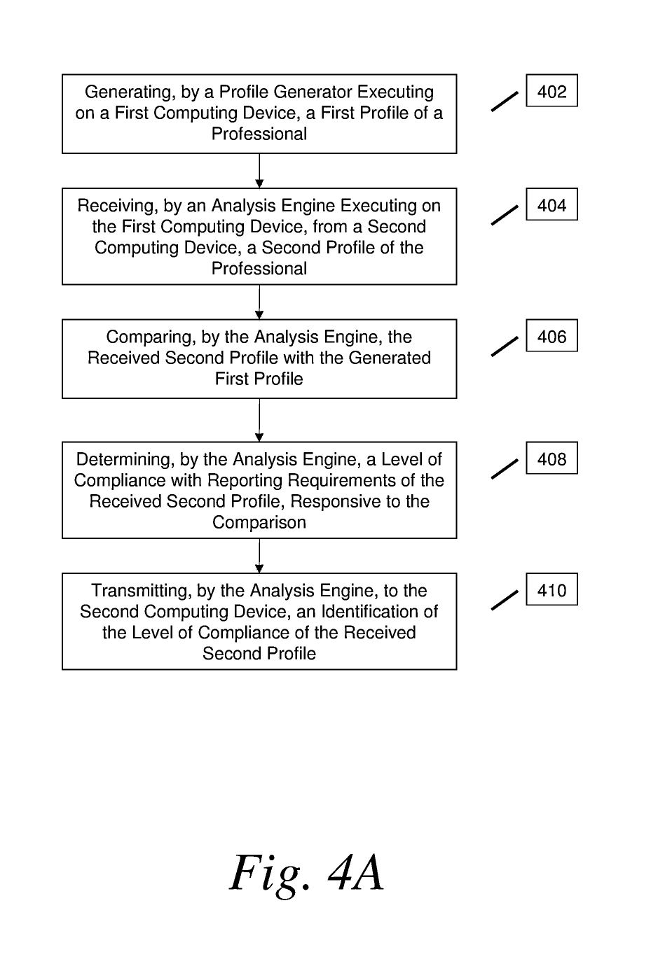

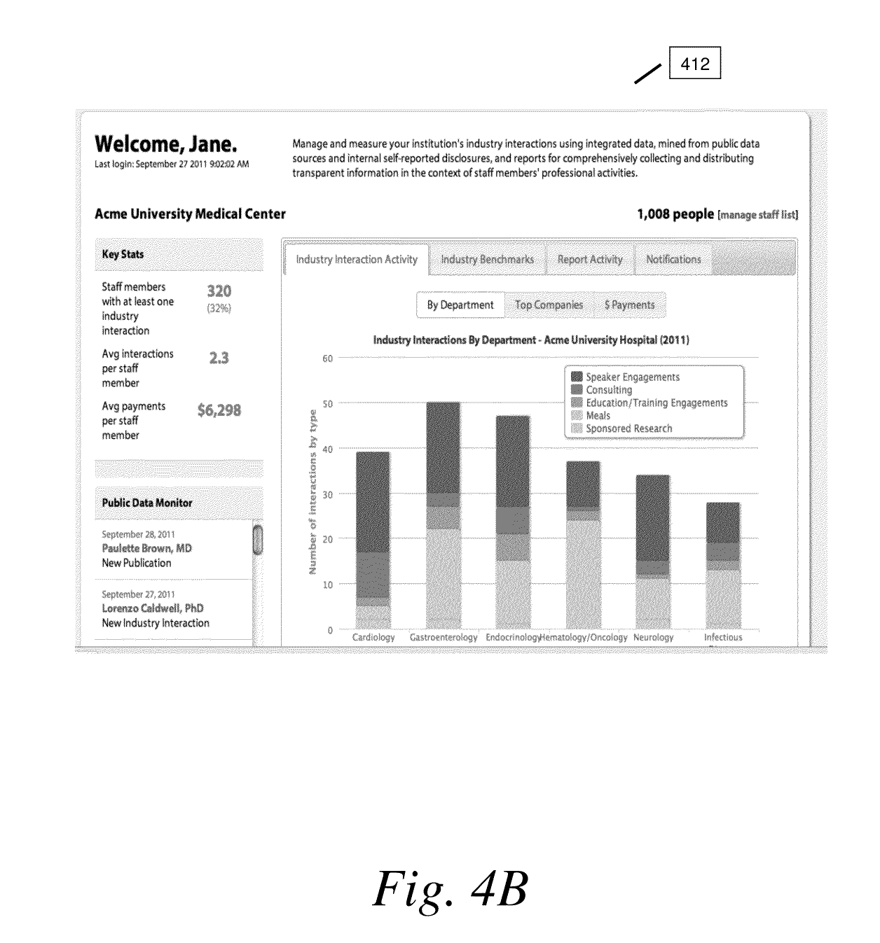

Referring now to FIG. 4A, and in connection with FIG. 2, a flow diagram depicts one embodiment of a method for verifying a level of compliance of professional profile data. In brief overview, the method includes generating, by a profile generator executing on a first computing device, a first profile of a professional (402). The method includes receiving, by an analysis engine executing on the first computing device, from a second computing device, a second profile of the professional (404). The method includes comparing, by the analysis engine, the received second profile with the generated first profile (406). The method includes determining, by the analysis engine, a level of compliance with reporting requirements of the received second profile, responsive to the comparison (408). The method includes transmitting, by the analysis engine, to the second computing device, an identification of the level of compliance of the received second profile (410).

Referring to FIG. 4A, and in greater detail, a profile generator executing on a first computing device generates a first profile of a professional (402). In one embodiment, the profile generator 202 generates the profile as described above in connection with FIGS. 2 and 3.

The method includes receiving, by an analysis engine executing on the first computing device, from a second computing device, a second profile of the professional (404). In one embodiment, the analysis engine 204, described above in connection with FIGS. 2 and 3, receives the second profile.

In some embodiments, the second profile is a profile generated by the professional. For example, the professional may have manually generated a profile containing self-reported data. The professional may have submitted the profile to a third party, such as an employer, an organization for whom the professional consults, an organization hosting an event at which the professional makes a presentation, or other third party.

In one embodiment, the analysis engine 204 receives, from the professional, the second profile; for example, the professional may send the second profile to the analysis engine 204 to confirm compliance with one or more reporting requirements before submitting the report. In another embodiment, the analysis engine 204 receives the second profile from a third party, such as an employer of the professional; for example, the professional has submitted the second profile to a third party (such as an employer, reporting bureau, or other organization) and the third party submits the second profile to the analysis engine 204 to confirm compliance.

The analysis engine compares the received second profile with the generated first profile (406). In one embodiment, the analysis engine 204 determines whether there are any discrepancies between the two profiles. In another embodiment, the analysis engine 204 determines whether there is any information missing from either or both profiles. In some embodiments, the analysis engine 204 performs comparative benchmarking at the individual level as well as the “global” level (e.g., all interactions available to the analysis engine 204). In other embodiments, the analysis engine 204 generates alerts for outlier values.

In some embodiments, the analysis engine 204 compares the information in the two profiles against disclosure requirements of various reporting agencies. Professionals may be required to disclose industry activity by various agencies, including for example, employers (e.g., hospitals, universities), professional associations (e.g., the American Medical Association), state and federal governments, and other regulatory bodies (e.g., the Securities and Exchange Commission). In the medical industry, by way of example, there may be hundreds of regulatory bodies with distinct disclosure requirements with which a professional needs to comply. In the sports industry, as another example, there may be varying levels of compliance based on the levels at which an athlete competes. Other industries in which professionals need to comply with reporting requirements include, by way of example, the financial, legal, non-profit, education, and political industries. In some embodiments, the methods and systems described herein provide functionality allowing both the professional and the regulatory body to easily identify requirements and confirm compliance with the different applicable disclosure rules.

The analysis engine determines a level of compliance with reporting requirements of the received second profile, responsive to the comparison (408). In one embodiment, the analysis engine 204 determines that there are no discrepancies between the generated first profile and the received second profile. In another embodiment, the analysis engine 204 determines that the received second profile complies with reporting requirements applicable to the professional.

In some embodiments, the analysis engine 204 determines that the received second profile is not in compliance with applicable reporting requirements. In other embodiments, the analysis engine 204 determines that the received second profile is in compliance with a reporting requirement in a first jurisdiction and also determines that the received second profile is not in compliance with a reporting requirement in a second jurisdiction.

In one embodiment, the analysis engine 204 identifies information included in the generated first profile and not included in the received second profile (for example, the professional may have omitted a speaking engagement or publication in the self-reported profile). In another embodiment, the analysis engine 204 transmits, to the professional, an identification of a modification to apply to the received second profile, responsive to the comparison with the generated profile. In another of these embodiments, the analysis engine 204 transmits, to an employer of the professional, an identification of a modification to apply to the received second profile, responsive to the comparison with the generated profile. For example, the analysis engine 204 may transmit to the professional, or to a third party, an identification of a modification needed to bring the second profile into compliance. In some embodiments, and as will be discussed in further detail below, the analysis engine 204 generates a disclosure report on behalf of the professional based upon the generated first profile.

The analysis engine transmits, to the second computing device, an identification of the level of compliance of the received second profile (410). In one embodiment, the analysis engine 204 transmits to the professional, the identification of the level of compliance. In another embodiment, the analysis engine 204 transmits to an employer of the professional, the identification of the level of compliance. In still another embodiment, the analysis engine 204 transmits to a third party (such as an organization with which the professional is currently associated or has applied to become associated, a government agency, an academic organization, or other third party) the identification of the level of compliance.

In one embodiment, the prediction engine 208 generates a prediction of a future level of compliance by the professional. For example, a professional who maintains accurate and compliant profiles may be more likely to maintain a certain level of compliance than a professional whose level of compliance varies widely within a period of time. In some embodiments, the prediction engine 208 conducts a longitudinal analysis of a professional's professional activities, determines patterns, and compares the result against global benchmarks. In other embodiments, the prediction engine 208 predicts behavior based on external factors, such as changes to hospital or industry policies, product launches, new funding events, and other economic conditions, as well as based on user-generated information (inferring from the information factors such as, e.g., accuracy, honesty).

Referring now to FIG. 4B, a screen shot depicts one embodiment of a user interface displaying a profile of an institution. As shown in FIG. 4B, an interface 412 may depict numbers and types of interactions, details about the types of individuals within the institution who interacted with industry and other data assisting an institution in evaluating an impact of staff members' professional activities on the institution. In some embodiments, the analysis engine 204 analyzes a level of compliance to determine an impact on a level of expertise of the profiled professional. In one of these embodiments, the analysis engine 204 identifies a correlation between a level of compliance and a level of expertise; for example, a professional having a high level of compliance may be more likely to have a higher level of expertise than a professional with an inconsistent level of compliance. Furthermore, the analysis engine 204 may modify a level of expertise of an institution based upon levels of compliance of the institution's employees; for example, a hospital known to employ doctors with high compliance levels may be more influential than another institution. Such benchmarking may benefit the institutions (for example, with fund raising or attracting talent), the employees (for example, with salaries or industry opportunities), and professionals doing business with institutions and employees (for example, organizations seeking influential speakers or vendors seeking to promote products with influential industry leaders).

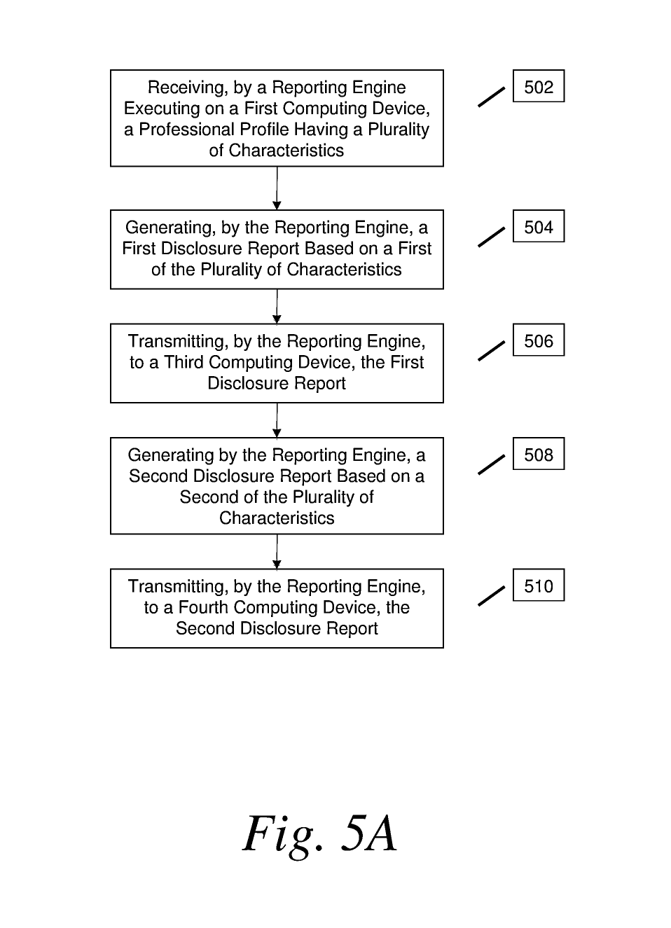

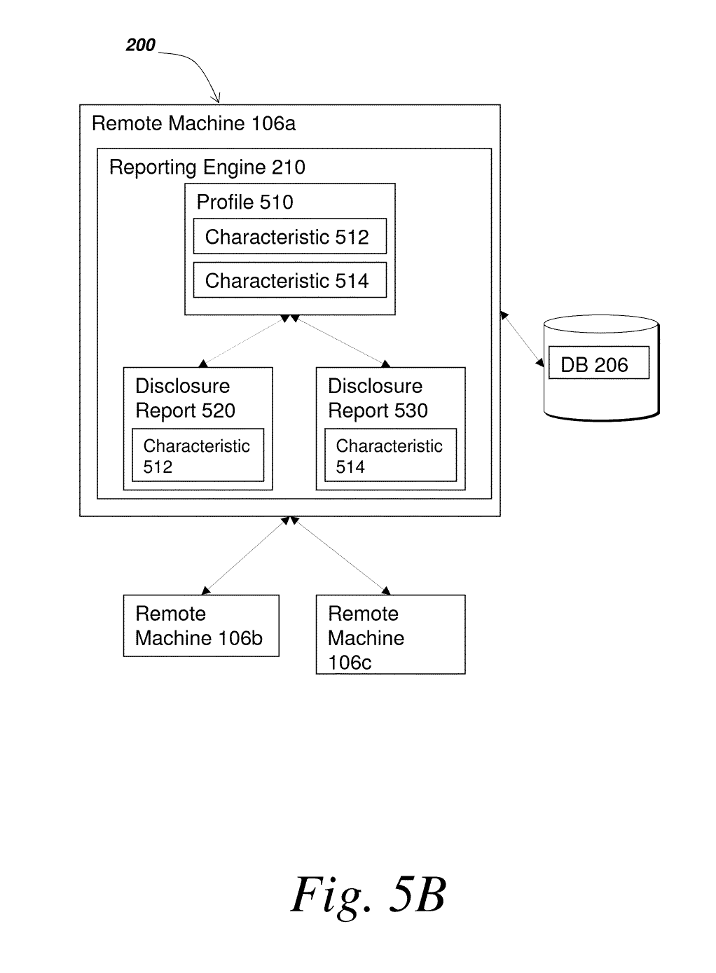

Referring now to FIG. 5A, a flow diagram depicts one embodiment of a method for generating and transmitting customized disclosure reports for professionals. In brief overview, the method includes receiving, by a reporting engine executing on a first computing device, a professional profile having a plurality of characteristics (502). The method includes generating, by the reporting engine, a first disclosure report based on a first of the plurality of characteristics (504). The method includes transmitting, by the reporting engine, to a third computing device, the first disclosure report (506). The method includes generating by the reporting engine, a second disclosure report based on a second of the plurality of characteristics (508). The method includes transmitting, by the reporting engine, to a fourth computing device, the second disclosure report (510).

Referring now to FIG. 5A, and in connection with FIG. 2, the reporting engine receives a professional profile having a plurality of characteristics (502). In one embodiment, the reporting engine 210 receives the professional profile from the profile generator 202. In another embodiment, the reporting engine 210 retrieves the professional profile from the database 206. In still another embodiment, the reporting engine 210 receives the professional profile from the analysis engine 204. In yet another embodiment, the reporting engine 210 receives the professional profile from a professional via a client computing device 102.

The reporting engine generates a first disclosure report based on a first of the plurality of characteristics (504). In one embodiment, the reporting engine 210 receives an identification of the first of the plurality of characteristics for use in generating the first disclosure report. In another embodiment, the reporting engine 210 receives an identification of the second of the plurality of characteristics for use in generating the second disclosure report. For example, the reporting engine 210 may receive the identifications from the professional, via the client computing device 102. As another example, the reporting engine may retrieve the identifications from the database 206 or from a database 206b maintained by a regulatory agency. The reporting engine transmits, to a third computing device, the first disclosure report (506). The reporting engine generates a second disclosure report based on a second of the plurality of characteristics (508). The reporting engine transmits, to a fourth computing device, the second disclosure report (510).

In one embodiment, the reporting engine 210 receives a modification to the professional profile. For example, the reporting engine 210 may receive the modification from the profile generator 202 or from a remote computing device such as one used by the professional or by a third party. In another embodiment, the reporting engine 210 transmits, to at least one of the third computing device and the fourth computing device, a modified version of at least one of the first disclosure report and the second disclosure report. In some embodiments, when the reporting engine 210 receives a modification to the professional profile, the reporting engine 210 transmits the modification to a third party.

In one embodiment, the reporting engine 210 predicts which elements of a profile the professional requires in which disclosure report. In another embodiment, the reporting engine 210 predicts that a subset of the plurality of characteristics will be required by the professional in the first disclosure report. In still another embodiment, the reporting engine 210 predicts that a subset of the plurality of characteristics will be required by the professional in the second disclosure report.

Referring now to FIG. 5B, a block diagram depicts one embodiment of a system generating and transmitting customized disclosure reports for professionals. As depicted in FIG. 5B, the reporting engine 210 receives a profile 510 including a characteristic 512 and a characteristic 514. In one embodiment, the reporting engine 210 determines that the profiled professional is required to disclose characteristic 512 to a first organization and to disclose characteristic 514 to a second organization. In another embodiment, the reporting engine 210 generates a disclosure report 520 containing characteristic 512 and generates a disclosure report 530 containing characteristic 514. In still another embodiment, the reporting engine 210 transmits the disclosure report 520 to the remote machine 106b, maintained by the first organization and transmits the disclosure report 530 to the remote machine 106c, maintained by the second organization.

By way of example, in one embodiment, the profile generator 202 generates a profile for a doctor and the reporting engine 210 receives the generated profile. In this example, the reporting engine 210 identifies a first characteristic of the professional that needs to be disclosed to the doctor's employer (e.g., the hospital that employs the doctor has a policy requiring that all doctors disclose speaking engagements for which they were paid a certain amount) and identifies a second characteristic of the professional that needs to be disclosed to the doctor's academic association (e.g., a local association of medical school faculty may require that members disclose how much money they make from consulting with pharmaceutical companies). Continuing with this example, the reporting engine 210 generates reports containing the appropriate characteristics for each entity to which the doctor needs to disclose aspects of the profile. As a further example, should the doctor or the profile generator 202 add a characteristic to the profile (e.g., a new relationship with a medical device company, or a new publication), the reporting engine 210 identifies which disclosure reports need to be updated and transmits the updated report to the appropriate institution. In such an embodiment, the methods and systems described herein provide the professional with functionality for managing the disparate disclosure requirements imposed on the professional.

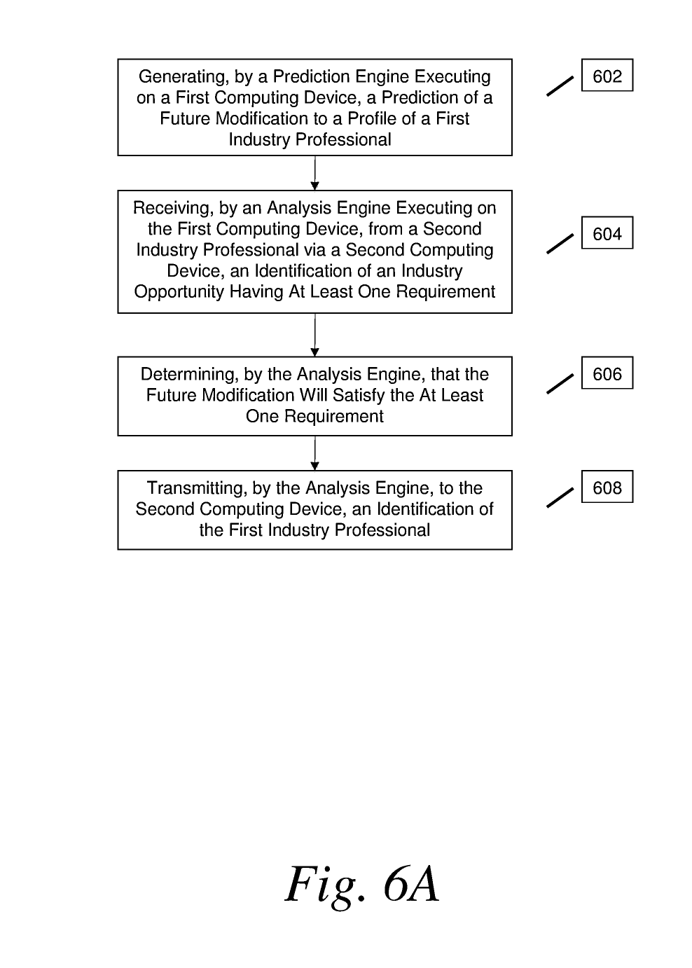

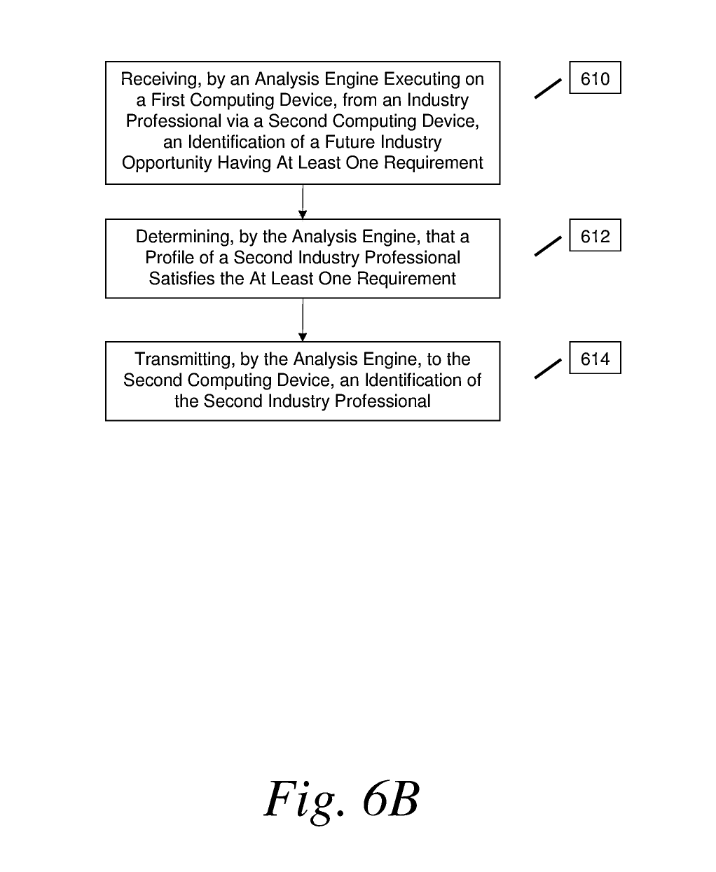

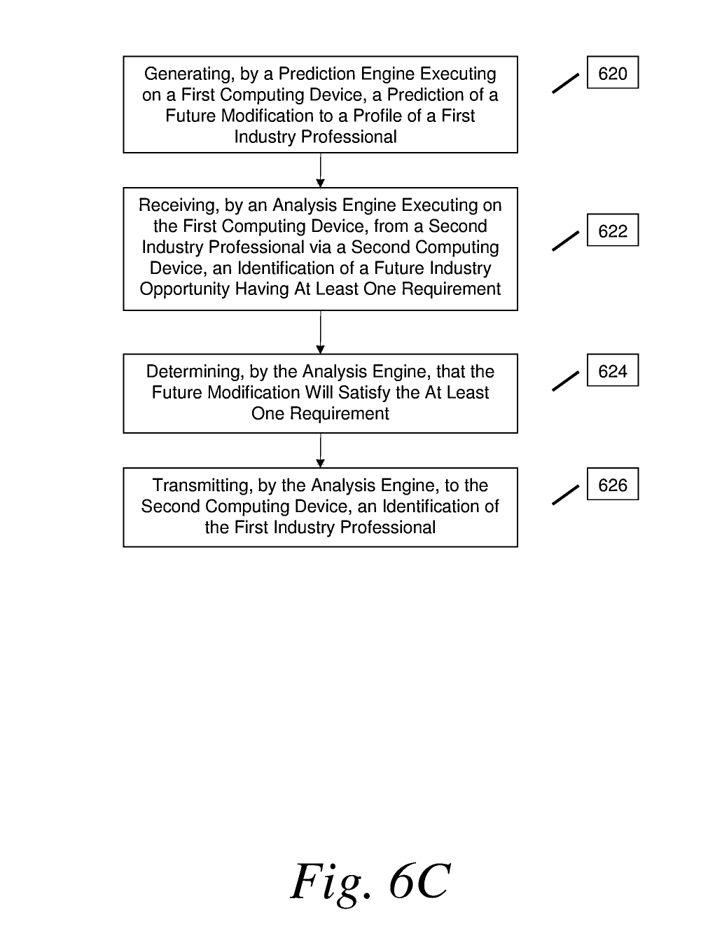

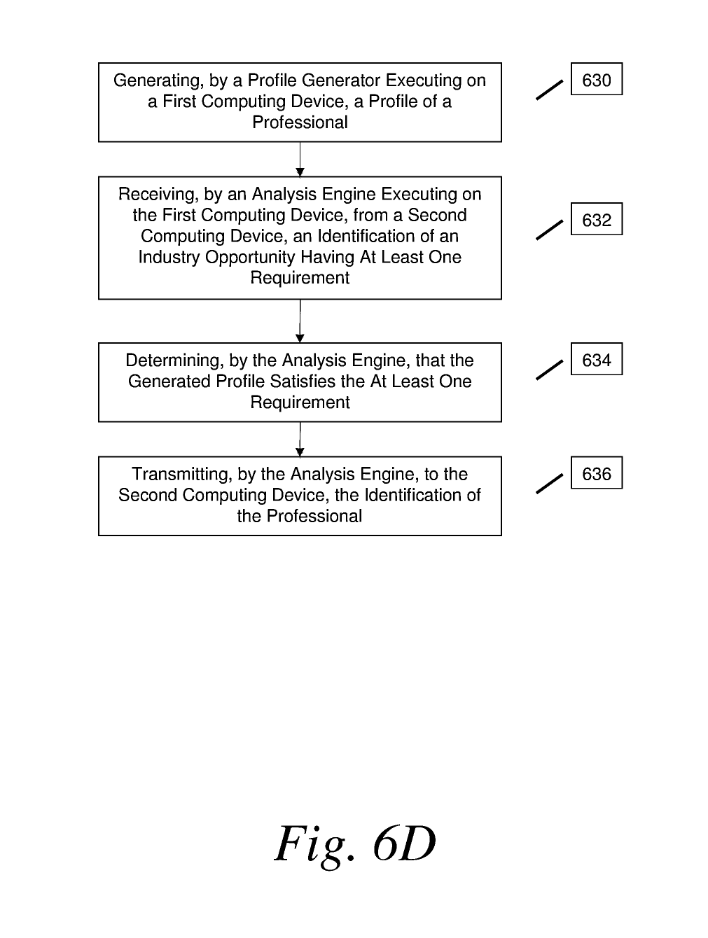

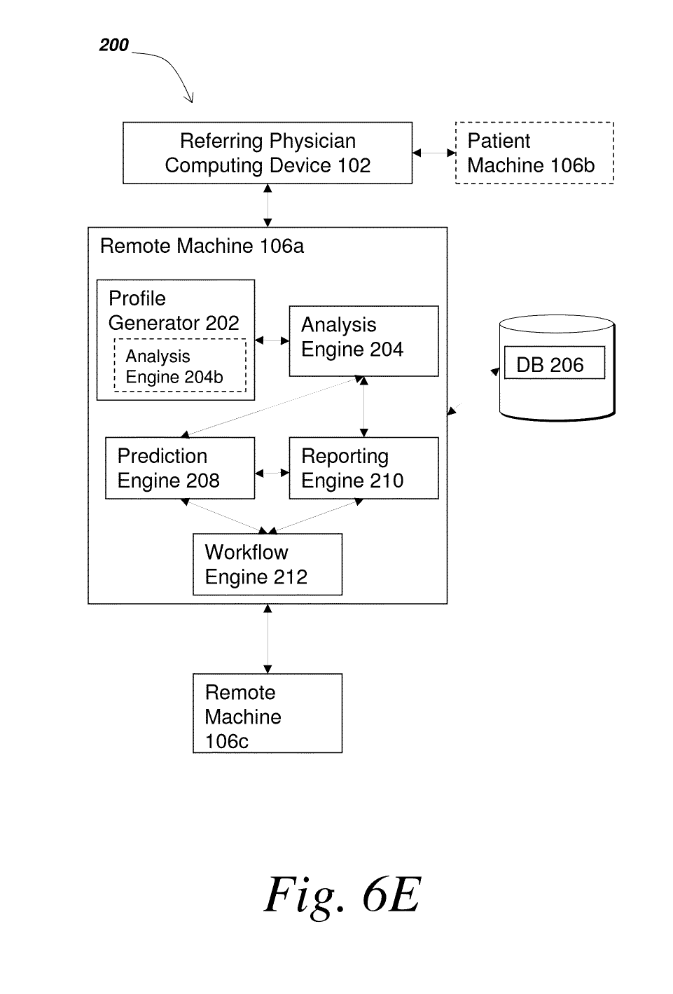

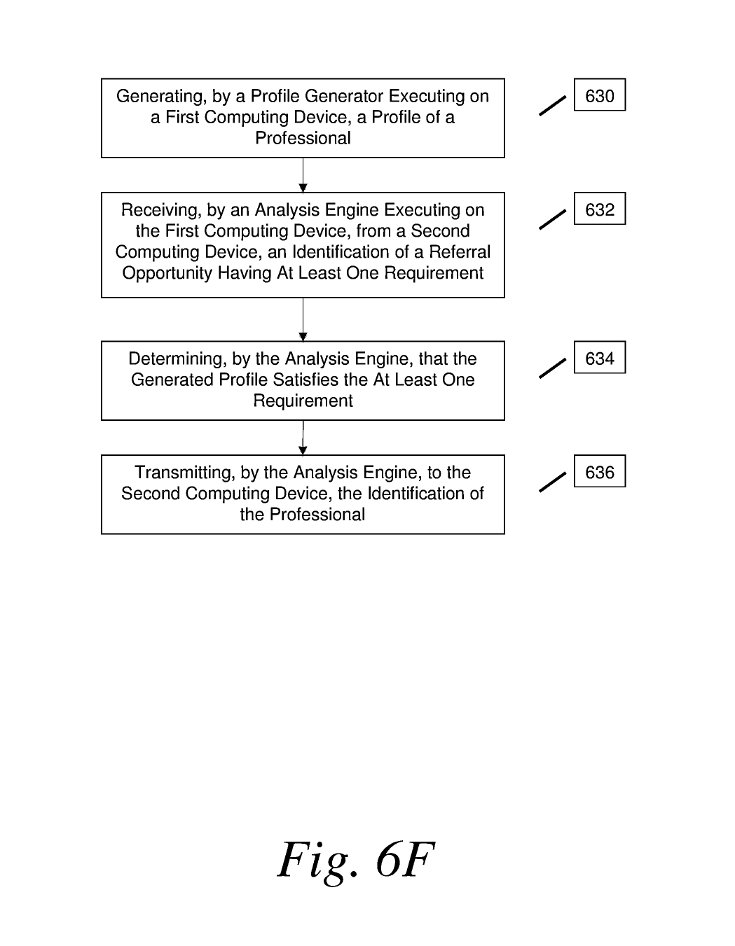

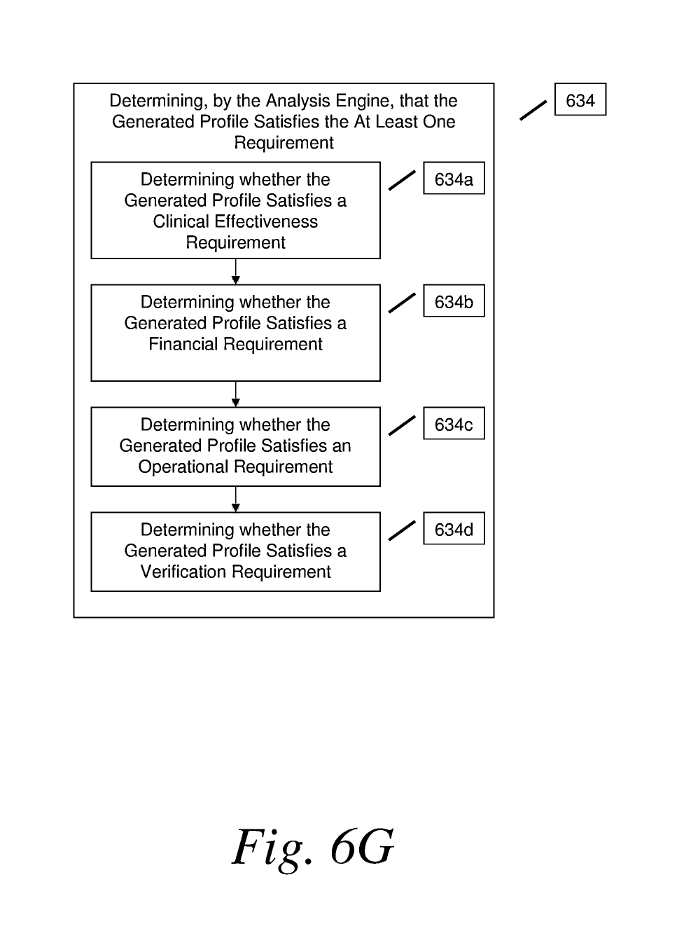

Referring now to FIG. 6A, a flow diagram depicts one embodiment of a method for identifying a future match between a professional and an industry opportunity. In brief overview, the method includes generating, by a prediction engine executing on a first computing device, a prediction of a future modification to a profile of a first industry professional (602). The method includes receiving, by an analysis engine executing on the first computing device, from a second industry professional via a second computing device, an identification of an industry opportunity having at least one requirement (604). The method includes determining, by the analysis engine, that the future modification will satisfy the at least one requirement (606). The method includes transmitting, by the analysis engine, to the second computing device, an identification of the first industry professional (608).

Referring now to FIG. 6A in greater detail, and in connection with FIG. 2, the prediction engine 208 generates a prediction of a future modification to a profile of a first industry professional (602). Industry professionals may include any individual associated with a particular industry—for example, academics researching various aspects of the industry (e.g., professors), individuals providing consumer-facing or business-to-business services (e.g., employees or affiliates of professional services firms or hospitals), and vendors providing goods and services to individuals providing consumer-facing or business-to-business services may all be considered industry professionals.

In one embodiment, the prediction engine 208 compares the profile of the first industry professional with a profile of a third industry professional to predict the future modification. For example, prediction engine 208 may analyze the first industry professional's network and identify a third industry professional more senior to the first industry professional whose career path was similar to the first industry professional's path; the prediction engine 208 may then determine that a modification to the third industry professional's profile is likely to occur to the first industry professional's profile in the future. In another example, the prediction engine 208 may analyze profiles of the first industry professional's classmates, colleagues, or industry peers to make the prediction. In another embodiment, the prediction engine 208 performs predictive modeling based on longitudinal data sets. In still another embodiment, the prediction engine 208 performs a deterministic analysis based on data and a probabilistic prediction and analysis of future outcomes. In some embodiments, the predictive engine 208 operates as described above in connection with FIGS. 3 and 4.

The analysis engine 204 receives, from a second industry professional via a second computing device, an identification of an industry opportunity having at least one requirement (604). The remote machine 106 may execute, for example, a web server displaying a web page from which the industry professional may submit industry opportunities. Industry opportunities include, by way of example, and without limitation, speaking opportunities, consulting opportunities, employment opportunities, referral opportunities, opportunities to become involved with clinical trials, publication opportunities, and membership opportunities. In some embodiments, and as will be discussed in greater detail below, the analysis engine 204 receives an identification of future opportunities as well as current opportunities.

The analysis engine 204 determines that the future modification will satisfy the at least one requirement (606). In one embodiment, the analysis engine 204 performs a search to identify a profiled industry professional who satisfies the at least one requirement. In another embodiment, and by way of example, the analysis engine 204 performs a search of all profiles containing future modification fields to identify a profile having a future modification that satisfies the at least one requirement. Alternatively, and in another embodiment, the analysis engine 204 performs a search of all industry opportunities to identify an industry opportunity having at least one requirement satisfied by the future modification.

The analysis engine 204 transmits, to the second computing device, an identification of the first industry professional (608). In one embodiment, the analysis engine 204 transmits the identification to the second industry professional. In some examples, the second industry professional subscribes to receive updates regarding candidates that satisfy the requirements of industry opportunities. By way of example, and without limitation, the analysis engine 204 may generate a message for transmission to the second industry professional identifying the future modification and the industry professional (e.g., “You have indicated that you are seeking additional members for a marketing panel for a drug launch happening in six months. This doctor will have completed a fellowship at an institution that makes her a strong candidate for your team. You may contact her at the number below.”; the analysis engine 204 may also facilitate connections between the professional and third parties). In another embodiment, the analysis engine 204 transmits the identification of the industry opportunity to the first industry professional. By way of example, and without limitation, the analysis engine 204 may generate a message for transmission to the first industry professional identifying the future modification and the industry opportunity (e.g., “Dear Doctor, based upon our analyses, we believe that in three years, you will have completed your work leading phase two of clinical trials for this medical device and will be qualified for industry opportunities like this one.”; “Dear Attorney, based upon our analyses, we believe you will have completed your L.L.M degree in three days and will be qualified to speak at this event sponsored by the American Bar Association”). In some examples, the first industry professional subscribes to receive updates regarding potential industry opportunities.

As discussed in FIG. 6A, a modification to a professional profile in the future may result in qualification for an industry opportunity. In other embodiments, and as discussed below in connection with FIG. 6B, a professional profile may satisfy the requirements of a future industry opportunity. For example, an industry professional planning a future industry opportunity may request information relating to professional profiles of individuals who currently match the requirements of the planned opportunity.

Referring now to FIG. 6B, a flow diagram depicts one embodiment of a method for identifying a future match between a professional and an industry opportunity. The method includes receiving, by an analysis engine executing on a first computing device, from an industry professional via a second computing device, an identification of a future industry opportunity having at least one requirement (610). The method includes determining, by the analysis engine, that a profile of a second industry professional satisfies the at least one requirement (612). The method includes transmitting, by the analysis engine, to the second computing device, an identification of the second industry professional (614).

Referring to FIG. 6B in greater detail, the analysis engine 204 receives, from an industry professional via a second computing device, an identification of a future industry opportunity having at least one requirement (610). In one embodiment, the analysis engine 204 receives the identification of the future industry opportunity as discussed above in connection with FIG. 6A. Future industry opportunities may include, by way of example, opportunities planned either in the near future or in the long term. For example, an industry professional organizing an event in a few months may post an identification of an opportunity for speakers and an industry professional seeking physicians to manage a future phase of a clinical trial may post an identification of the opportunity years in advance. Additional examples of opportunities include, without limitation, opportunities for interaction with or for joining speakers' bureaus, employment recruiting groups, guidelines committee members (e.g., with the FDA), hospital departments (e.g., job offers or referral opportunities), pharmacy committees, paper reviews/editorials, interviews by media, and marketing opportunities.

The method includes determining, by the analysis engine, that a profile of a second industry professional satisfies the at least one requirement (612). In one embodiment, the analysis engine 204 accesses one or more database to identify a matching profile. In another embodiment, the analysis engine 204 insures that each match satisfies at least one criteria and, within a set of individuals satisfying at least one criteria, further determines, based on a plurality of characteristics of each individual in the set, the best potential match; in addition to identifying the best potential match, the analysis engine 204 may also rank individuals in the set.

The method includes transmitting, by the analysis engine, to the second computing device, an identification of the second industry professional (614). In some embodiments, the analysis engine 204 transmits an identification of the future industry opportunity to the second industry professional.

Referring now to FIG. 6C, a flow diagram depicts one embodiment of a method for identifying a future match between an industry professional and an industry opportunity. In brief overview, the method includes generating, by a prediction engine executing on a first computing device, a prediction of a future modification to a profile of a first industry professional (620). The method includes receiving, by an analysis engine executing on the first computing device, from a second industry professional via a second computing device, an identification of a future industry opportunity having at least one requirement (622). The method includes determining, by the analysis engine, that the future modification will satisfy the at least one requirement (624). The method includes transmitting, by the analysis engine, to the second computing device, an identification of the first industry professional (626).

Referring to FIG. 6C, and in greater detail, the prediction engine 208 generates a prediction of a future modification to a profile of a first industry professional (620). In one embodiment, the prediction engine 208 generates the prediction as described above in connection with FIG. 6A.

The analysis engine 204 receives, from a second industry professional via a second computing device, an identification of a future industry opportunity having at least one requirement (622). In one embodiment, the analysis engine 204 receives the identification of the future industry opportunity as described above in connection with FIGS. 6A and 6B.

The analysis engine 204 determines that the future modification will satisfy the at least one requirement (624). In one embodiment, the analysis engine 204 makes this determination as described above in connection with FIG. 6A. The method includes transmitting, by the analysis engine, to the second computing device, an identification of the first industry professional (626). In one embodiment, the analysis engine 204 transmits the identification of the industry opportunity to the first industry professional.

Referring now to FIG. 6D, a flow diagram depicts one embodiment of a method for matching a professional and an industry opportunity. In brief overview, the method includes generating, by a profile generator executing on a first computing device, a profile of a professional (630). The method includes receiving, by an analysis engine executing on the first computing device, from a second computing device, an identification of an industry opportunity having at least one requirement (632). The method includes determining, by the analysis engine, that the generated profile satisfies the at least one requirement (634). The method includes transmitting, by the analysis engine, to the second computing device, the identification of the professional (636).

Referring now to FIG. 6D, and in greater detail, the profile generator 202 generates a profile of a professional (630). In one embodiment, the profile includes at least one identification of a connection of the professional. In another embodiment, the professional is associated with a level of expertise or a level of influence. In still another embodiment, the profile generator 202 generates the profile as described above in connection with FIGS. 2 and 3.

The method includes receiving, by an analysis engine executing on the first computing device, from a second computing device, an identification of an industry opportunity having at least one requirement (632). In one embodiment, the analysis engine 204 receives the identification as described above in connection with FIG. 6A.

The method includes determining, by the analysis engine, that the generated profile satisfies the at least one requirement (634). In some embodiments, the analysis engine 204 accesses the affinity index described above in connection with FIG. 2 in determining that the generated profile satisfies the at least one requirement. In other embodiments, the analysis engine 204 applies weights to the professional connections based on the relevance of attributes to the requirements (so that, for example, relevance changes based on the nature of the requirements). In further embodiments, the analysis engine 204 may access claims data in make the determination.

In one embodiment, the analysis engine 204 analyzes a characteristic of a professional's profile to determine whether the generated profile satisfies the at least one requirement of the industry opportunity. In another embodiment, the analysis engine 204 determines that the profiled professional is associated with an area of specialty identified in the at least one requirement. As an example, where the industry opportunity is for a speaking engagement at an event, an event organizer may have specified that professionals applying for the opportunity have a particular area of specialty. As another example, the requirement may specify, without limitation, a geographic region, a case history of the professional, a number of referrals to the professional by other professionals, case outcome (e.g., statistical data on case outcomes), or availability of the professional to participate in the opportunity.

In one embodiment, the analysis engine 204 analyzes the professional connections of the professional to determine whether the profile satisfies the at least one requirement. As an example, and without limitation, the analysis engine 204 may review a profiled professional's network, identify an individual in the network with whom the profiled professional went to graduate school and who attended the same seminars on a specialized area of (for example) medicine as the profiled professional and who provided a positive review of the profiled professional's speaking abilities, and determine, based on the connection to the identified individual that the profiled professional satisfies the requirement of an industry opportunity for a qualified speaker knowledgeable in the specialized area of medicine. As another example, a plurality of profiled professionals may be identified who satisfy the requirements although they are not personally connected to each other; in such an example, the plurality of profiled professionals who satisfy the requirements are identified by a means other than analyzing the individuals in their networks.

In some embodiments, the analysis engine 204 generates a predictive referral. In one of these embodiments, for example, the analysis engine 204 analyzes at least one characteristic of a professional's profile to determine whether the professional is best suited for a particular opportunity, or to identify an alternative professional that would be better suited for the particular opportunity. For example, the analysis engine 204 may identify for a first doctor a plurality of professionals whose profiles indicate they would be well suited for a particular referral and then predict which of the plurality of professionals would be best suited for the referral via, for example, rank-ordering of the plurality of professionals.

The method includes transmitting, by the analysis engine, to the second computing device, the identification of the professional (636). In one embodiment, the analysis engine 204 transmits the identification of the industry opportunity to the professional. In another embodiment, the analysis engine 204 transmits an identification of the professional to an individual affiliated with the industry opportunity.

As discussed above in connection with FIG. 6D, the methods and systems described herein provide functionality for matching qualified professionals with particular opportunities. Described in connection with FIG. 6D as “industry opportunities,” such opportunities may include a broad range of opportunities and the phrase is not intended to limit the type of opportunities for which the system may identify qualified professionals. For example, to a doctor working at a hospital, an opportunity to consult with a pharmaceutical company may be considered an industry opportunity. As another example, however, to another doctor seeking a job, an opportunity to work at the hospital may be considered an industry opportunity. As a further example, to students still in undergraduate or graduate school, opportunities to work in any setting outside of academia may be considered industry opportunities. As another example, to an attorney, consultant, or other individual providing services to consumers or to other businesses, a referral to a potential new client may be considered an industry opportunity. A hospital seeking to hire an expert in a particular practice area (based, for example, on population demand) may consider the posting an industry opportunity. A pharmaceutical company planning a clinical trial and in need of a specialist in the area of the clinical trial may consider the opportunity to work on the clinical trial an industry opportunity. As these examples illustrate, a broad variety of opportunities are encompassed by the phrase “industry opportunity” and the phrase is not intended to limit the scope of the disclosure to any one particular type of opportunity.

Having described matching professionals with current industry opportunities above, FIGS. 6E-6F below describe one embodiment of methods and systems for matching professionals with referral opportunities. Referral opportunities may be considered one type of industry opportunity, where one professional is seeking to refer an individual to a second professional and uses the methods and systems described herein to identify the second professional. In some embodiments, the methods and systems described herein provide functionality for efficiently routing an individual to a profiled professional having an appropriate level of expertise or influence and satisfying the requirements of the individual and the referring professional.

Referring now to FIG. 6F, and in connection with FIG. 6E, a flow diagram depicts one embodiment of a method for matching a professional and a referral opportunity. In brief overview, the method includes generating, by a profile generator executing on a first computing device 106a, a profile of a professional (630). The method includes receiving, by an analysis engine executing on the first computing device 106a, from a second computing device 102, an identification of a referral opportunity having at least one requirement (632). The method includes determining, by the analysis engine, that the generated profile satisfies the at least one requirement (634). The method includes transmitting, by the analysis engine, to the second computing device 102, the identification of the professional (636).

Referring now to FIG. 6F, in greater detail and still in connection with FIG. 6E, the profile generator 202 generates a profile of a professional (630). In one embodiment, the profile generator 202 generates the profile as described above in connection with FIGS. 2 and 3.

The method includes receiving, by an analysis engine executing on the first computing device, from a second computing device, an identification of a referral opportunity having at least one requirement (632). In one embodiment, the analysis engine 204 receives the identification from a computing device 106a as described above in connection with FIG. 6A. In another embodiment, the analysis engine 204 receives the identification of the referral opportunity from a referring physician computing device 102. In still another embodiment, the analysis engine 204 receives the identification of the referral opportunity from a remote machine 106c associated with a third party entity such as, without limitation, a hospital, insurance company, business, or other entity seeking to hire or refer business to a profiled professional satisfying a requirement of the referral opportunity.

As described above, industry opportunities include a variety of types of opportunities, including referral and employment opportunities. By way of example, and without limitation, a referral opportunity may be an opportunity to work at a particular hospital or to be hired by a particular patient. In some embodiments, the analysis engine 204 may receive the identification of the referral opportunity from a referring physician computing device 102 associated with a first healthcare professional. As another example, the analysis engine 204 may receive, from a computing device 102 associated with a first healthcare professional, an identification of an opportunity for a second healthcare professional (e.g., an opportunity for a first doctor to refer a patient to a second doctor). In one of these embodiments, therefore, the analysis engine 204 receives, from the referring physician computing device 102, an identification of a referral opportunity having at least one requirement. In another of these embodiments, the analysis engine 204 receives, from the referring physician computing device 102, an identification of an employment opportunity having at least one requirement. In still another of these embodiments, the analysis engine 204 receives, from another machine, such as a remote machine 106c associated with a hiring organization (e.g., a hospital, university, company, or other entity), an identification of an employment opportunity having at least one requirement.

The identification of the industry opportunity may specify one or more requirements. For example, and without limitation, the identification may specify that a first doctor will only refer a patient to a second doctor if the second doctor specializes in a particular area of medicine, has a particular success rate in performing a type of medical procedure, accepts patients covered by a particular insurer, or is employed by a particular healthcare organization. As another example, and without limitation, the identification may specify that a first doctor will only recommend a second doctor for a job if the second doctor specializes in a particular area of medicine, has a particular success rate in performing a type of medical procedure, accepts patients covered by a particular insurer, or has a particular level of expertise.

In some embodiments, the remote machine 106a includes business logic (including pre-configured business rules that may be, for example, specific to a particular referring professional or organization) for determining whether the generated profile satisfies the at least one requirement. In other embodiments, the remote machine 106a provides a user interface allowing a referring professional to generate and transmit search queries to the remote machine 106a in order to refer a subject of a referral opportunity to a qualified professional.

The method includes determining, by the analysis engine, that the generated profile satisfies the at least one requirement (634). In one embodiment, the analysis engine 204 analyzes a characteristic of a professional's profile to determine whether the generated profile satisfies the at least one requirement. In some embodiments, the analysis engine 204 accesses the affinity index described above in connection with FIG. 2 in determining that the generated profile satisfies the at least one requirement. In other embodiments, the analysis engine 204 applies weights to one or more professional connections of the profiled professional based on the relevance of attributes to the requirements (so that, for example, relevance changes based on the nature of the requirements). In further embodiments, the analysis engine 204 may access claims data in making the determination.

In one embodiment, the analysis engine 204 receives an identification of a diagnosis. For example, an individual associated with the referring physician computing device 102 may accesses the remote machine 106a and provide, via a user interface made available by the remote machine 106a, an identification of a referral opportunity and an identification of a diagnosis of a patient associated with the referral opportunity. For instance, a referring physician (independently or in collaboration with one or more staff members) may visit with a patient, diagnose the patient with a particular illness or condition, determine a need to refer the patient to a second physician (e.g., a specialist in working with patients with the diagnosed condition), and generate a description of the referral opportunity, of the patient, and of the diagnosis. In another embodiment, in which a first individual has contacted an organization associated with a plurality of physicians and requested assistance with a condition, a second individual associated with the organization (e.g., a staff member), may determine that the first individual should be referred to a primary care physician, specialist, or other healthcare professional and generate a request for identification of an appropriate physician with which to connect the first individual. For example, a first individual may contact a hospital (either in person or via telephone or electronic communications) and request access to a doctor to treat a condition; a staff member interacting with the first individual may transmit a request to the remote machine 106a for an identification of a physician able to see the first individual in connection with the condition. In another embodiment, the analysis engine 204 makes an identification of a profiled professional qualified to accept the referral opportunity based upon the received information (e.g., the identification of the referral opportunity, an identification of a diagnoses, and at least one requirement of the referral opportunity) and an analysis of one or more professional profiles.

Referring ahead to FIG. 6G, a flow diagram depicts an embodiment of the method described in connection with FIG. 6F. As shown in FIG. 6G, the method includes determining, by the analysis engine, that the generated profile satisfies the at least one requirement of the referral opportunity; the determination may include several sub-determinations before the analysis engine 204 concludes, based on the analyses, that a particular professional is qualified for a particular referral opportunity. As depicted in FIG. 6G, determining that the generated profile satisfies the at least one requirement may include determining whether the generated profile satisfies a clinical effectiveness requirement (634a). Determining that the generated profile satisfies the at least one requirement may include determining whether the generated profile satisfies a financial requirement (634b). Determining that the generated profile satisfies the at least one requirement may include determining whether the generated profile satisfies an operational requirement (634c). Determining that the generated profile satisfies the at least one requirement may include determining whether the generated profile satisfies a verification requirement (634d). Alternative embodiments of determining that the generated profile satisfies the at least one requirement (634) may include making a sub-set (e.g., some, all or none) of the determinations described in connection with FIG. 6G.

Determining that the generated profile satisfies the at least one requirement may include determining whether the generated profile satisfies a clinical effectiveness requirement (634a). In one embodiment, determining whether the generated profile satisfies a clinical effectiveness requirement may include, for example and without limitation, determining whether the profiled professional satisfies a requirement regarding a particular clinical experience or a requirement regarding a level of quality of care provided by the profiled professional. In another embodiment, the analysis engine 204 determines that the profiled professional is associated with an area of specialty identified in the at least one requirement. For example, the analysis engine 204 may determine whether the profiled professional is associated with an area of specialty identified in the at least one requirement. As another example, the requirement may specify, without limitation, a case history of the profiled professional, a number of referrals to the profiled professional by other industry professionals, or prior patient outcome (e.g., statistical data on patient outcomes for patients seen by the profiled professional, such as rate of readmission or patient compliance with medical treatment).

In some embodiments, the analysis engine 204 analyzes third party input to determine whether the generated profile satisfies the at least one requirement. For example, the analysis engine 204 may analyze data generated by the referring professional (e.g., particular personal experience of the referring professional with one or more profiled professional). In another example, the analysis engine 204 may analyze data generated by a peer of either the referring professional or the profiled professional. In a further example, the analysis engine 204 analyzes data associated with a subject of the referral opportunity; for instance, the analysis engine 204 may analyze data associated with a patient including diagnoses, past history, prior successful or unsuccessful treatments, and patient preferences.

Determining that the generated profile satisfies the at least one requirement may include determining whether the generated profile satisfies a financial requirement (634b). For example, the analysis engine 204 may determine whether a cost profile for a profiled professional satisfies the at least one requirement by determining whether the profiled professional satisfies a threshold level of cost effectiveness. As an example, the analysis engine 204 may determine a level of cost efficiency of the profiled professional generally or for a specific procedure. In some embodiments, the analysis engine 204 may analyze data associated with the professional although not explicitly in the profile, such as billing data, to make the determination. In other embodiments, the analysis engine 204 may analyze data associated with the professional but not in the profile at all. In one of these embodiments, for example, the analysis engine 204 accesses an eligibility lookup system (such as, for example, a system which may be provided by an insurance company) to determine whether, and to what extent, an insurance company covers one or more patient-physician interactions and whether the level of coverage satisfies the at least one requirement of the referral opportunity.

Determining that the generated profile satisfies the at least one requirement may include determining whether the generated profile satisfies an operational requirement (634c). For example, the analysis engine 204 may determine whether the profiled professional has availability in his or her schedule to undertake the referral opportunity, which may include an identification of a timeframe within which the referral appointment should take place. The analysis engine 204 may determine whether the profiled professional's geographic region or other location-based characteristic satisfies the at least one requirement.

Determining that the generated profile satisfies the at least one requirement may include determining whether the generated profile satisfies a verification requirement (634d). In some embodiments, the remote machine 106a provides functionality both for identifying a profiled professional who satisfies the requirements of the referral opportunity and for connecting the profiled professional with a subject of the referral opportunity. In one of these examples, after the analysis engine 204 determines that the profiled professional satisfies the requirements of the referral opportunity, the remote machine 106a completes a verification process as part of the process of connecting the profiled professional with a subject of the referral opportunity. For example, the workflow engine 212 may maintain a state for each part of the verification process and generate a notification at the completion of each required stage. By way of example, in an embodiment in which the referral opportunity specified a requirement relating to insurance, the workflow engine 212 may maintain a state for a request, by the analysis engine 204, from an insurance company or a remote machine 106c associated with the insurance company, for confirmation of eligibility of a patient to see a profiled physician.

As an additional example of determining whether the generated profile satisfies a verification requirement, the workflow engine 212 may verify association with a network (including, e.g., hospital networks, accountable care networks, or other organizational structure of a hospital system). As another example of determining whether the generated profile satisfies a verification requirement, the workflow engine 212 may verify patient eligibility verification, including, for example, insurance verification, and other patient-oriented verification metrics. As an additional example of determining whether the generated profile satisfies a verification requirement, the workflow engine 212 may verify one or more credentials, including, for example, such factors as whether the profiled professional has an active license and no disciplinary actions.

In some embodiments, the remote machine 106a provides feedback to one or more other computing devices throughout the process of analyzing profiles and selecting profiled professionals who qualify for one or more referral opportunities. For example, the remote machine 106a may provide feedback to a referring physician computing device 102 identifying characteristics of a referral opportunity that impacted the selection of a profiled professional. As another example, the remote machine 106a may provide feedback to a profiled professional identifying attributes of the profile that impacted the qualification of the profiled professional for a referral opportunity. As another example, the workflow engine 212 may provide feedback to various computing devices identifying points in a verification process at which particular profiles were approved or filtered out (e.g., indicating to a referring physician that no insurance company would cover a particular type of referral or indicating to a profiled professional that he or she did or did not qualify for a referral opportunity based on insurance plans accepted, hours available, geography served, or other characteristic).

In some embodiments, therefore, the analysis engine 204 generates a predictive referral based upon one or more types of analyses of one or more profiled professionals. In one of these embodiments, for example, the analysis engine 204 analyzes at least one characteristic of a professional's profile to determine whether the professional is best suited for a particular patient, or to identify an alternative professional that would be better suited for the particular patient. For example, the analysis engine 204 may identify for a first doctor a plurality of professionals whose profiles indicate they would be well suited for a particular referral and then predict which of the plurality of professionals would be best suited for the referral via, for example, rank-ordering of the plurality of professionals. In such an embodiment, the system may provide personalized predictive modeling of patient outcomes, using physician characteristics as inputs.

Referring back to FIG. 6F, the method includes transmitting, by the analysis engine, to the second computing device, the identification of the professional (636). In one embodiment, the analysis engine 204 transmits the identification of the referral opportunity to the referring physician computing device 102. In another embodiment, the analysis engine 204 transmits the identification of the referral opportunity to the profiled professional. In some embodiments, the methods and systems described herein provide functionality allowing the referring physician to contact the profiled professional regarding the referral opportunity. In other embodiments, the methods and systems described herein provide functionality for scheduling an appointment between the subject of the referral opportunity and the profiled professional. In further embodiments, the methods and systems described herein provide functionality for transacting a referral such that the referring professional maintains coordination of care and shares appropriate data with the appropriate parties to effect the transaction. In one of these embodiments, the methods and systems described herein further provide functionality allowing the referring professional to connect with the subject of the referral during and after the completion of the referred work, to follow up with the subject of the referral regarding a level of quality of the subject's experience.

In some embodiments, the remote machine 106a integrates with one or more remote machines to provide the functionality described herein. For example, in one embodiment, the remote machine 106a is in communication with a remote machine 106c that provides access to electronic medical records from which the remote machine 106a can identify data associated with the profiled professional (e.g., outcomes of patients previously treated by a physician) and data associated with the subject of the referral opportunity (e.g., a case history, diagnoses, previous effective treatments, or other patient data). As another example, the remote machine 106a may be in communication with customized databases (e.g., databases containing patient or physician data). As a further example, the remote machine 106a may be in communication with scheduling systems, eligibility lookup systems, and clinical environments generally.

In some embodiments, the remote machine 106a is in communication with a bidding system (not shown). For example, the remote machine 106a may incorporate or be in communication with a financial market bidding system in which healthcare providers bid for referral opportunities based on at least one of price and quality (e.g., allowing a referring physician to identify the best doctor available for the lowest fees). An entity such as an accountable care organization may make a determination as to what tests or procedures they are willing to offer at particular price points in order to qualify for particular referral opportunities.

In one embodiment, therefore, the methods and systems described herein provide functionality for data-driven management of referrals between physicians. In contrast to existing systems where a physician seeking to make a referral is typically limited to individuals of which the physician is aware (e.g., other physicians known to the referring physician), and which are conventionally based on subjective knowledge of the referring physician, implementation of the methods and systems herein provide functionality for objectively identifying relevant physicians, regardless of a personal connection between the two physicians, while assuring the referring physician that the person to whom he or she is sending a patient satisfies any needs, desires, or requirements the patient has. By way of example, a referring physician may have a patient requesting access to a physician practicing in a specified geographic location but the referring physician may not know any practicing physicians in the specified geographic location who also satisfy a requirement of the referring physician (such as, a particular medical specialty, or level of expertise, or accepting new patients within a particular time frame); however, rather than having to refer the patient to someone unknown to the referring physician or to someone that fails to satisfy the patient's requests, the referring physician may utilize the methods and systems described herein to identify an appropriate physician to which to refer the patient.

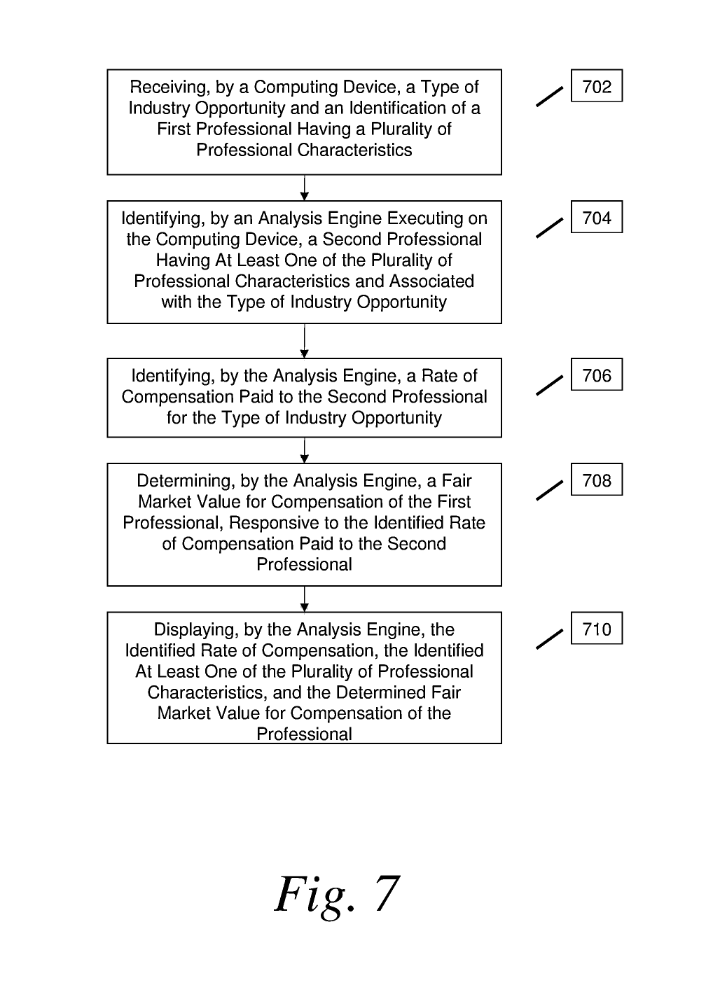

Referring now to FIG. 7, a flow diagram depicts one embodiment of a method for identifying a fair market value for compensating a professional. In brief overview, the method includes receiving, by a computing device, a type of industry opportunity and an identification of a first professional having a plurality of professional characteristics (702). The method includes identifying, by an analysis engine executing on the computing device, a second professional having at least one of the plurality of professional characteristics and associated with the type of industry opportunity (704). The method includes identifying, by the analysis engine, a rate of compensation paid to the second professional for the type of industry opportunity (706). The method includes determining, by the analysis engine, a fair market value for compensation of the first professional, responsive to the identified rate of compensation paid to the second professional (708). The method includes displaying, by the analysis engine, the identified rate of compensation, the identified at least one of the plurality of professional characteristics, and the determined fair market value for compensation of the professional (710).

In some embodiments, an individual hiring a professional for an industry opportunity, or a professional being hired, needs to identify the fair market value of the professional's time in order to determine a rate of compensation for the professional. In one of these embodiments, the methods and systems described herein provide functionality allowing individuals to calculate a fair market value based upon what other professionals were paid for similar opportunities. By providing access to a fair market value based upon a large number of professionals without requiring the individual being hired or doing the hiring to take on the process of identifying and interviewing those professionals in order to calculate a fair market value, and by providing a fair market value generated by evaluating compensation for similar types of opportunities by similar types of professionals, the methods and systems described herein provide an improved experience to users.

Referring now to FIG. 7 in greater detail, the method includes receiving, by a computing device, a type of industry opportunity and an identification of a first professional having a plurality of professional characteristics (702). In one embodiment, the remote machine 106 executes a web server displaying a web page from which a user at a client device 102 can provide the type of industry opportunity and the identification of the first professional. In another embodiment, the remote machine 106 has previously matched the professional with the type of industry opportunity (e.g., as described above in connection with FIGS. 6A-D) and retrieves information associated with the match from a data store, such as database 206.

An analysis engine executing on the computing device identifies a second professional having at least one of the plurality of professional characteristics and associated with the type of industry opportunity (704). In one embodiment, by way of example, the analysis engine 204 determines that the second professional has a similar educational background and professional experience as the first professional and that the second professional has given a talk for the same organization that the first professional is about to speak to, or has written an article in the same publication, or has had an experience analogous to the type of industry opportunity the first professional is undertaking.

The analysis engine identifies a rate of compensation paid to the second professional for the type of industry opportunity (706). In some embodiments, the analysis engine 204 determines rates of compensation paid to a plurality of professionals; by way of example, and without limitation, the analysis engine 204 may perform a comprehensive analysis of how much was paid to every speaker at a particular industry event for the history of the event, or of how much each medical consultant with an MD practicing a certain specialty in a particular geographic region was compensated by a pharmaceutical company and by the pharmaceutical company's peers.

The analysis engine determines a fair market value for compensation of the first professional, responsive to the identified rate of compensation paid to the second professional (708). In one embodiment, the fair market value is a range that is tiered and dynamically computed from actual market data (as opposed to existing standard methods that infer market rates from loosely related financial information). In another embodiment, the analysis engine 204 leverages at least one profile attribute for the analysis. In still another embodiment, the analysis engine 204 incorporates into the determination application of nearest neighbor analysis, the relative ranking/comparative analysis, comparing input models, and outlier analysis of compensation.

The analysis engine displays the identified rate of compensation, the identified at least one of the plurality of professional characteristics, and the determined fair market value for compensation of the professional (710). In some embodiments, the methods and systems described herein provide the professional and the organization hiring the professional with detailed information including the rates of compensation for similarly qualified professionals working on similar types of opportunities, highlighting the particular characteristics that qualify the professionals for these rates, and calculating the fair market value for compensation for this particular professional.

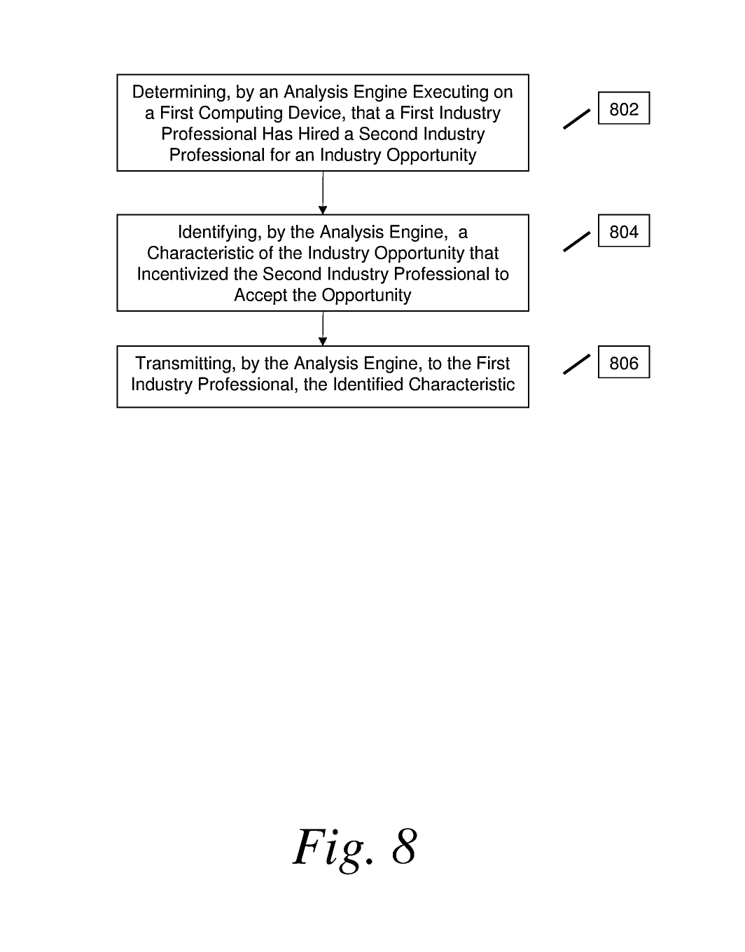

Referring now to FIG. 8, a flow diagram depicts one embodiment of a method for identifying an incentive provided by an industry opportunity for a professional. In brief overview, the method includes determining, by an analysis engine executing on a first computing device, that a first industry professional hired a second industry professional for an industry opportunity (802). The method includes identifying, by the analysis engine, a characteristic of the industry opportunity that incentivized the second industry professional to accept the opportunity (804). The method includes transmitting, by the analysis engine, to the first industry professional, the identified characteristic (806).

Referring now to FIG. 8, and in greater detail, the analysis engine 204 determines that a first industry professional hired a second industry professional for an industry opportunity (802). In one embodiment, the remote machine 106 identified the match between the industry opportunity and the second industry professional and stored data relating to the match (e.g., in the database 206); the analysis engine 204 retrieves data relating to stored matches to determine that the first industry professional hired the second industry professional. In another embodiment, the first industry professional provides the analysis engine 204 with an identification of at least one other industry professional hired for the industry opportunity and requests an identification of a characteristic of the industry opportunity that incentivized the second industry professional to accept the opportunity. In some embodiments, the first industry professional requests an identification of a third industry professional who will also be incentivized by similar opportunities. In other embodiments, the first industry professional provides the analysis engine 204 with an identification of at least one other industry professional hired for the industry opportunity and requests an identification of a level of expertise or influence of the hired second industry professional.

In still other embodiments, the first industry professional provides the analysis engine 204 with an identification of at least one other industry professional hired for the industry opportunity and requests an identification of another industry professional over whom the hired second industry professional has a level of influence. For example, if the second industry professional is viewed as influential by mentees, employees, co-authors, or other professionals, the system may identify those individuals to the first industry professional, who may then choose to approach the identified individuals regarding similar opportunities. As another example, the first industry professional may request an identification of the types of industry professionals with whom the hired second industry professional is influential in order to understand how useful hiring the second industry professional was in furthering a business objective of the first industry professional (e.g., in seeking to persuade the medical community of the efficacy of a medical device, a vendor of the device may wish to first give a very influential member of the medical community an opportunity to use the device on a trial basis, or may evaluate the utility of a particular member of the medical community who has signed up to use the device on a trial basis, based on how influential that member is with others in the community).

The analysis engine 204 identifies a characteristic of the industry opportunity that incentivized the second industry professional to accept the opportunity (804). In some embodiments, the analysis engine 204 analyzes a behavior of the second industry professional to identify the characteristic. In other embodiments, the analysis engine 204 analyzes an industry opportunity that the second industry professional declined to identify the characteristic. In still other embodiments, the analysis engine 204 analyzes a plurality of industry opportunities and the decisions of a plurality of industry professionals to accept or decline each of the plurality of industry opportunities.

In one embodiment, the analysis engine 204 receives, from the second industry professional, a modification to a profile of the professional subsequent to accepting the opportunity. In another embodiment, the analysis engine 204 analyzes the modification to identify an incentive the opportunity provided. By way of example, if a doctor accepts a speaking opportunity and immediately updates a profile generated by the profile generator 202 to reflect a connection to an institution before whom the doctor spoke, the ability to connect to the institution may be the characteristic of the opportunity that incentivized the doctor to accept the opportunity. As another example, if the industry opportunity has a plurality of characteristics, a majority of which may be seen as disincentives but the doctor accepts the opportunity in spite of that, the analysis engine 204 may analyze the minority of characteristics to identify the one most likely to have incentivized the doctor (e.g., if a speaking opportunity takes place during a holiday season at a location geographically remote from the doctor's primary places of employment and residence, and the location is not a peak tourist location or a location in which the doctor has any professional or personal connections (as identified by the profile generator 202), and the location is not the primary place of business for an institution with a high level of influence in the doctor's industry, but the location has better weather conditions than the doctor's primary places of employment and residence or pays three times what a typical speaking opportunity pays, the analysis engine 204 may determine that good weather or financial opportunity were what incentivized the doctor to accept). In one embodiment, the analysis engine 204 analyzes a plurality of opportunities accepted by a plurality of industry professionals in order to identify the characteristic. For example, the analysis engine 204 may analyze a statistically significant number of pairings between professionals and opportunities in order to identify the characteristic.

The analysis engine 204 transmits, to the first industry professional, the identified characteristic (806). In some embodiments, the analysis engine 204 performs further analysis on the opportunity-professional pairing to identify additional opportunities for professionals. In one embodiment, the analysis engine 204 transmits to the second industry professional the identified characteristic and an identification of another industry opportunity also having the identified characteristic (e.g., “Dear Doctor, it appears you are attempting to increase the number of teaching hospitals where you develop personal connections after a speaking opportunity. You may be interested in the following opportunities with similar institutions”). In other embodiments, the analysis engine 204 performs further analysis on the opportunity-professional pairing to identify characteristics professionals should include when creating new opportunities. In another embodiment, the analysis engine 204 transmits, to the first industry professional, an identification of a third industry professional likely to be incentivized by the same characteristics (e.g., “Dear Sales Representative for Pharmaceutical Company XYZ, you attract more doctors to agree to listen to your sales pitch when you offer them introductions to other doctors in your network than when you offer to take them to lunch. You may wish to revise your pending opportunities”).

As discussed in connection with FIG. 8, the methods and systems described herein provide functionality for identifying the incentive provided to a medical professional by a characteristic of an opportunity (a characteristic such as, by way of example, a fee paid, an introduction made, or a professional development opportunity). In other methods however, it is a characteristic of the professional that provides an incentive for other industry professionals to contact the professional—for example, a reputation for being available to speak with other industry professionals, or a large professional network and a reputation for being willing to make introductions.

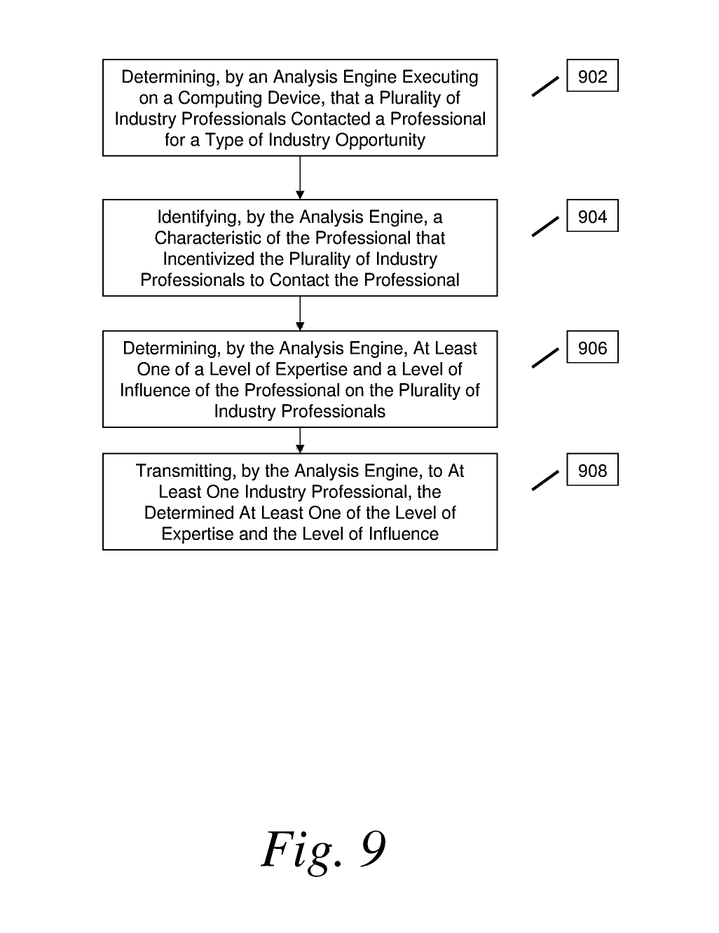

Referring now to FIG. 9, a flow diagram depicts one embodiment of a method for identifying a level of influence of a professional on an industry professional. In brief overview, the method includes determining, by an analysis engine executing on a computing device, that a plurality of industry professionals contacted a professional for a type of industry opportunity (902). The method includes identifying, by the analysis engine, a characteristic of the professional that incentivized the plurality of industry professionals to contact the professional (904). The method includes determining, by the analysis engine, at least one of a level of expertise and a level of influence of the professional on the plurality of industry professionals (906). The method includes transmitting, by the analysis engine, to at least one industry professional, the determined at least one of the level of expertise and the level of influence (908).

Referring now to FIG. 9, and in greater detail, the analysis engine 204 determines that a plurality of industry professionals contacted a professional for a type of industry opportunity (902). In one embodiment, industry professionals are, for example, sales representatives for vendors providing solutions to the professional and his or her peers. In another embodiment, industry professionals are provided with an application executing on a client computing device 102 (such as a mobile device) for use in managing contacts and relationships (e.g., a customer/contact relationship management application); the application may communicate with the remote machine 106 when an industry professional interacts with the application and identify the type of interaction. For example, if the application includes a listing of professionals whom the industry professional could contact, the application may track interactions by the industry professional, determine that the industry professional has selected an identification of the professional and contacted the professional by using the application to send an email or place a call; the application may then send a message to the remote machine 106 identifying the professional.

The method includes identifying, by the analysis engine, a characteristic of the professional that incentivized the plurality of industry professionals to contact the professional (904). In one embodiment, the analysis engine 204 identifies a characteristic of an individual and overlays the characteristic with market demand; for example, the analysis engine 204 may compare at least one characteristic of the individual with other industry professionals using a clustering algorithm that incorporates all of the characteristics of individuals in the population (such as, for example, where the individual went to school, where he or she has published written works, and how many speeches he or she has given). In another embodiment, the analysis engine 204 analyzes macroeconomic conditions, such as demand for a particular expertise within a specialty area.

The method includes determining, by the analysis engine, at least one of a level of expertise and a level of influence of the professional on the plurality of industry professionals (906). In one embodiment, the analysis engine 204 determines the at least one of the level of expertise and the level of influence as described above in connection with FIG. 3A.

The method includes transmitting, by the analysis engine, to at least one industry professional, the determined at least one of the level of expertise and the level of influence (908). In one embodiment, the analysis engine 204 identifies a second professional having the identified characteristic and transmits, to at least one industry professional, an identification of the second professional.

In some embodiments, rather than determine that a plurality of industry professionals contacted the professional about a type of industry, the analysis engine 204 determines that a plurality of clients contacted the professional about a type of good or service. In one of these embodiments, by way of example, the analysis engine 204 determines that a plurality of patients contacted a doctor to receive a medical treatment. In another of these embodiments, as a further example, the clients contact a lawyer to receive legal counsel or contact a consultant to receive business advice. Although some of the examples provided herein relate to professional services industries, one of ordinary skill in the art will understand that the methods and systems described herein are equally applicable to other industries and professions—for example, and without limitation, home buyers or sellers may contact realtors or financiers, students may contact professors or career counselors, and professionals may contact organizations to identify potential places of employment.

As discussed in connection with FIGS. 8 and 9, the methods and systems described herein provide functionality for identifying the incentive provided to a medical professional by a characteristic of an opportunity, or of the incentive provided by a characteristic of the medical professional. In other methods, however, a characteristic of a medical professional's network (instead of, for example, a characteristic of an opportunity of the medical professional) impacts the medical professional's behavior; an analysis of a medical professional's network and of the medical professional's behavior may result in an identification of a particular connection that impacts the medical professional's behavior. For example, an analysis of a doctor's prescribing patterns may indicate that the doctor favors products manufactured by a particular company and an analysis of the doctor's network, may indicate that the doctor has a significant number of professional connections with sales representatives employed by the company. The analysis engine 204, in this example, may generate a level of influence of the sales representatives on the doctor.

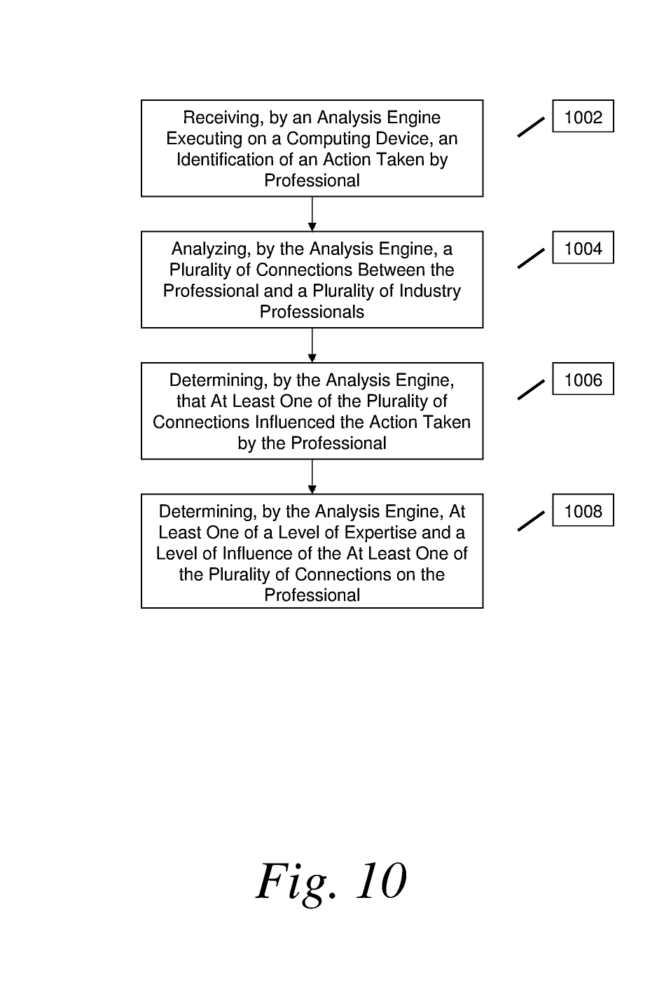

Referring now to FIG. 10, a flow diagram depicts one embodiment of a method for analyzing a level of influence of an industry professional on a professional. The method includes receiving, by an analysis engine executing on a computing device, an identification of an action taken by a professional (1002). The method includes analyzing, by the analysis engine, a plurality of connections between the professional and a plurality of industry professionals (1004). The method includes determining, by the analysis engine, that at least one of the plurality of connections influenced the action taken by the professional (1006). The method includes determining, by the analysis engine, at least one of a level of expertise and a level of influence of the at least one of the plurality of connections on the professional (1008).

Referring to FIG. 10, and in greater detail, the analysis engine 204 receives an identification of an action taken by a professional (1002). As described above, the analysis engine 204 may retrieve the identification from data stored by the remote machine 106 or may be provided the identification by a third party, such as the professional, an industry professional, and an employer of the professional.

The analysis engine 204 analyzes a plurality of connections between the professional and a plurality of industry professionals (1004). The analysis engine 204 determines that at least one of the plurality of connections influenced the action taken by the professional (1006). In one embodiment, the analysis engine 204 identifies a change in practice patterns as influenced by other physicians, industry professionals, or professional connections. For example, and without limitation, the analysis engine 204 may analyze a population of physicians to see where they were (e.g., geographically, where they lived, studied, or practiced) and with whom they interacted at the time of the change in practice patterns to identify a connection between the change in practice and the connections with whom they interacted (e.g., whether the change in practice patterns occurred after attending a conference or hearing a presentation by an industry professional); the analysis engine 204 could then apply the conclusion about the particular population of physicians analyzed to the whole population and predict and/or refine the model with further hypothesis testing using cluster algorithms.

The analysis engine 204 determines at least one of a level of expertise and a level of influence of the at least one of the plurality of connections on the professional (1008). In one embodiment, the analysis engine 204 determines the at least one of the level of expertise and the level of influence as described above in connection with FIG. 3A.

In one embodiment, the analysis engine 204 transmits the determined level of influence to the professional. In another embodiment, the analysis engine 204 transmits the determined level of influence to the industry professional. In still another embodiment, the analysis engine 204 transmits the determined level of influence to an employer of the professional.

In some embodiments, the analysis engine 204 generates a recommendation for modifying the level of influence. In one embodiment, for example, the analysis engine 204 may generate a recommendation for the industry professional regarding how they may increase their level of influence over professionals. For example, the analysis engine 204 may identify a characteristic of the industry professional that leads to a high level of influence of the industry professional and recommend having a colleague of the industry professional adopt the identified characteristic (e.g., an employer of a sales team may identify a highly successful sales representative and have the analysis engine 204 identify a characteristic that a second, less successful sales representative could incorporate). In another embodiment, the analysis engine 204 may generate a recommendation for a professional or an employer of a professional regarding how they may decrease the level of influence of industry professionals.

In one embodiment, methods and systems that identify correlations between network attributes and professional behavior may provide benefits to multiple parties: the professional may analyze his or her own behavior to better understand the influences on the behavior, a vendor of goods or services may analyze the correlation to determine the efficiency of a sales representative, or an employer of the professional may analyze the correlation to make determinations about quality of service provided by employees and levels of influence (appropriate or undue) by outside parties on their employees. The vendor of the goods or service may be, for example, a pharmaceutical company, a medical device company, or other vendor. However, the ‘vendor’ may also be an author of an influential paper, a judge or an entire court evaluating the impact of legal opinions, a consultant or a coach, or any other individual or entity seeking to influence a professional's behavior. By way of example, a hiring manager in a business may evaluate the behavior of a career development officer at an academic institution (the industry professional) to determine whether the career development officer is influential with graduating students (the professional) whom the business wishes to hire.

As discussed in connection with FIG. 10, the methods and systems described herein provide functionality for identifying a level of expertise or influence of a personal or professional connection on a professional's behavior. In other methods however, a pattern of behavior may be analyzed to identify a cause of the pattern of behavior. For example, a correlation may be identified between an attribute of the professional's profile and a change in the professional's behavior.

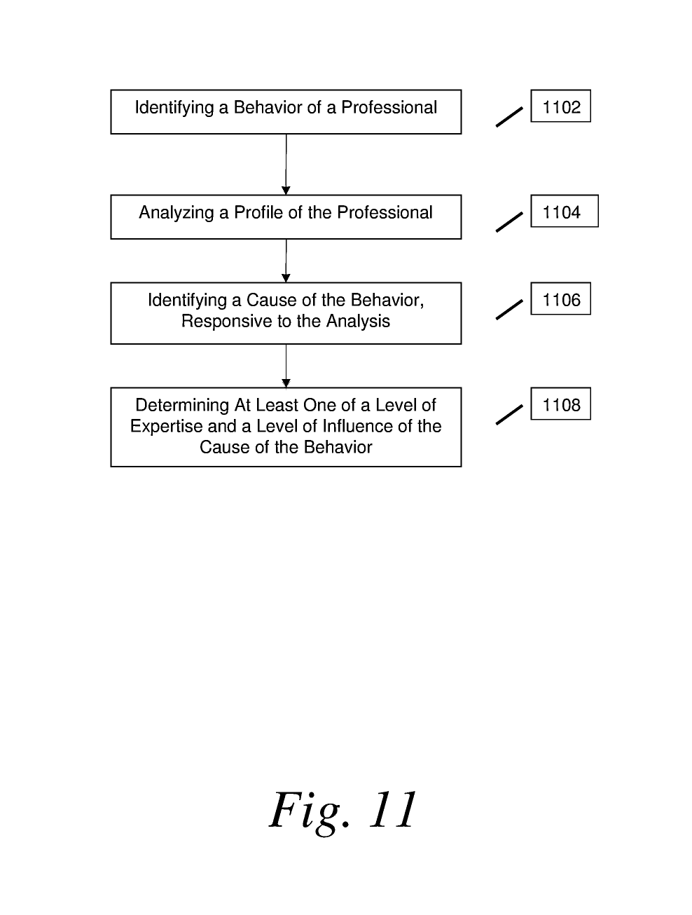

Referring now to FIG. 11, a flow diagram depicts one embodiment of a method for analyzing an influence on a behavior of a professional. The method includes identifying a behavior of a professional (1102). The method includes analyzing a profile of the professional (1104). The method includes identifying a cause of the behavior, responsive to the analysis (1106). The method includes determining at least one of a level of expertise and a level of influence of the cause of the behavior (1108).

Referring now to FIG. 11, and in greater detail, the analysis engine 204 identifies a behavior of a professional (1102). The analysis engine 204 analyzes a profile of the professional (1104). The analysis engine 204 identifies a cause of the behavior, responsive to the analysis (1106). In one embodiment, by understanding the external influences on professionals, the analysis engine 204 can measure and capture behavior going forward; examples of this include, without limitation, how a physician is affected by email or malpractice training.

By way of example, if the professional moves to a different geographic region, opines on a pivotal publication, participates in or is influenced by a major trial, or has a dramatic outcome as a result of a behavior (a patient dies, a client goes to jail, a company goes bankrupt), these events may influence the professional's future behavior. In cases where these events are captured in the professional's profile (as would be the case for many of these examples), an analysis of the profile may lead to identification of the cause of a precipitous change in the professional's behavior.

As another example of identifying a cause of behavior responsive to an analysis of a profile, the analysis engine 204 may analyze whether similar behavior by that individual has changed in the past. As a further example, of identifying a cause of behavior responsive to an analysis of a profile, the analysis engine 204 may analyze whether other profiled professionals with similar attributes (e.g., similar profiles) have changed their behaviors under similar circumstances.

The analysis engine 204 determines at least one of a level of expertise and a level of influence of the cause of the behavior (1108). In one embodiment, the analysis engine 204 generates the level of influence as described above in connection with FIG. 3A. In some embodiments, levels of influence may be associated not just with individuals or entities but also with events, opportunities, and actions. For example, an event may be said to have a high level of influence if attending the event impacts a behavior of an attendee.

Although some of the examples provided herein describe the analysis in connection with the medical profession, the legal profession, and other professional service industries, one of ordinary skill in the art will understand that the methods and systems described herein are equally applicable in other industries. Similarly, although the description above categorizes professionals as industry professionals (such as providers of goods or services), professionals such as physicians, and employers of professionals, it should be understood that any one individual may be categorized as any one or more of these types of professionals; for example, an industry professional need not be a vendor but could be a physician seeking to provide an opportunity to another physician and an employer in a particular instance may be better categorized as an industry professional. As discussed in an example given above, a hiring manager in a business (e.g., an employer) may evaluate the behavior of a career development officer at an academic institution (e.g., an industry professional) to determine whether the career development officer is influential with graduating students (e.g., professionals) whom the business wishes to hire.

It should be understood that the systems described above may provide multiple ones of any or each of those components and these components may be provided on either a standalone machine or, in some embodiments, on multiple machines in a distributed system. The phrases ‘in one embodiment’, ‘in another embodiment’, and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices; firmware; programmable logic; hardware (e.g., integrated circuit chip, electronic devices, a computer-readable non-volatile storage unit, non-volatile memory, such as semiconductor memory devices, including EPROM, EEPROM, and flash memory devices); magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for matching a professional with a referral opportunity, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for matching a professional with a referral opportunity, the method comprising:
generating, by a profile generator executing on a first computing device, a profile of a professional;
receiving, by an analysis engine executing on the first computing device, from a second computing device, an identification of a referral opportunity having at least one requirement;
determining, by the analysis engine, that the generated profile satisfies the at least one requirement; and
transmitting, by the analysis engine, to the second computing device, the identification of the professional.

2. The method of claim 1, wherein receiving further comprises receiving, by the analysis engine, from the second computing device, an identification of an employment opportunity having at least one requirement.

3. The method of claim 1, wherein receiving further comprises receiving an identification of a referral opportunity requiring the generated profile to identify a case history of the profiled professional.

4. The method of claim 1, wherein receiving further comprises receiving an identification of a referral opportunity specifying a required number of referrals to the profiled professional by other industry professionals.

5. The method of claim 1, wherein receiving further comprises receiving an identification of a referral opportunity specifying a required type of statistical data on patient outcomes for patients seen by the profiled professional.

6. The method of claim 1, wherein receiving further comprises receiving, by the analysis engine, from a second computing device, data associated with the subject of the referral.

7. The method of claim 1, wherein receiving further comprises receiving, by the analysis engine, a diagnosis of the subject of the referral.

8. The method of claim 1, wherein determining further comprises determining that the profiled professional is associated with an area of specialty identified in the at least one requirement.

9. The method of claim 1, wherein determining further comprises applying a weight to one or more professional connections of the profiled professional based on the relevance of an attribute of the one or more professional connections to the at least one requirement.

10. The method of claim 1, wherein determining further comprises accessing an affinity index.

11. The method of claim 1, wherein determining further comprises determining whether the profiled professional satisfies a requirement identifying a clinical experience.

12. The method of claim 1, wherein determining further comprises determining whether the profiled professional satisfies a requirement regarding a level of quality of care provided by the profiled professional.

13. The method of claim 1, wherein determining further comprises analyzing third party input to determine whether the generated profile satisfies the at least one requirement.

14. The method of claim 1, wherein determining further comprises analyzing data associated with a subject of the referral opportunity.

15. The method of claim 1, wherein determining further comprises determining whether the generated profile satisfies a financial requirement.

16. The method of claim 1, wherein determining further comprises determining whether the generated profile satisfies an operational requirement.

17. The method of claim 1, wherein determining further comprises verifying the association of the profiled professional with a network.

18. The method of claim 1, wherein determining further comprises verifying at least one credential of the profiled professional.

19. The method of claim 1, wherein determining further comprises matching prices for services listed in the professional profile with price limits imposed by the at least one requirement.

20. The method of claim 1, wherein determining further comprises determining a level of insurance coverage for a subject of the referral opportunity.

21. The method of claim 1, wherein determining further comprises:
retrieving a plurality of profiles for each of a plurality of professionals;
ranking the retrieved profiles; and
selecting the profile with the highest rank.

22. The method of claim 1, wherein transmitting comprises transmitting the identification of the referral opportunity to the profiled professional.

23. The method of claim 1 further comprising scheduling an appointment between a subject of the referral opportunity and the profiled professional.

24. A system for matching a professional with a referral opportunity, the system comprising:
a profile generator executing on a first computing device and generating a profile of a professional; and
an analysis engine (i) executing on the first computing device, (ii) receiving from a second computing device, an identification of a referral opportunity having at least one requirement, (iii) determining that the generated profile satisfies the at least one requirement, and (iv) transmitting, to the second computing device, the identification of the professional.

25. The system of claim 24, wherein the second computing device is operated by a staff member affiliated with a referring professional.

26. The system of claim 24, wherein the first computing device schedules an appointment for a subject of the referral opportunity with the professional.
